(19) United States
(12) Patent Application Publication
(10) Pub. No.: US 2012/0121129 A1
(43) Pub. Date: May 17, 2012

(54) IMAGE PROCESSING APPARATUS

(75) Inventor: Masayoshi Okamoto, Daito-shi (JP)

(73) Assignee: SANYO ELECTRIC CO., LTD., Osaka (JP)

(21) Appl. No.: 13/289,457

(22) Filed: Nov. 4, 2011

(30) Foreign Application Priority Data
Nov. 11, 2010 (JP) 2010-253147

(51) Int. Cl. G06K 9/00

(52) U.S. Cl. 382/103

(57) ABSTRACT

An image processing apparatus includes a first searcher. The first searcher searches for, from a designated image, one or at least two first partial images each of which represents a face portion. A second searcher searches for, from the designated image, one or at least two second partial images each of which represents a rear of a head. A first setter sets a region corresponding to the one or at least two first partial images detected by the first searcher as a reference region for an image quality adjustment. A second setter sets a region different from a region corresponding to the one or at least two second partial images detected by the second searcher as the reference region. A start-up controller selectively starts up the first setter and the second setter so that the first setter has priority over the second setter.

### CROSS REFERENCE OF RELATED APPLICATION

The disclosure of Japanese Patent Application No. 2010-253147, which was filed on Nov. 11, 2010, is incorporated here by reference.

### BACKGROUND OF THE INVENTION

1. Field of the Invention

The present invention relates to an image processing apparatus. More particularly, the present invention relates to an image processing apparatus which adjusts a quality of a designated image by detecting a face portion image.

2. Description of the Related Art

According to one example of this type of apparatus, a skin color region or a region of a face of a person is detected from a video signal. A luminance correction, a color correction and an aperture correction are executed to only the detected skin color region or face region. Moreover, the detected skin color region or face region is regarded as a photometric region for performing an autofocus, an iris control, an automatic gain control and a self-timer. Thereby, an image quality is adaptively improved.

However, in the above-described apparatus, a region which should not be referred to for adjusting the image quality is not actively detected, and an image quality adjusting process is not executed based on an image of a region different from such region, either. Thereby, in the above-described apparatus, there is a limit to the improvement of the image quality.

### SUMMARY OF THE INVENTION

An image processing apparatus according to the present invention, comprises: a first searcher which searches for, from a designated image, one or at least two first partial images each of which represents a face portion; a second searcher which searches for, from the designated image, one or at least two second partial images each of which represents a rear of a head in association with a searching process of the first searcher; a first setter which sets a region corresponding to the one or at least two first partial images detected by the first searcher out of regions on the designated image as a reference region for an image quality adjustment; a second setter which sets a region different from a region corresponding to the one or at least two second partial images detected by the second searcher out of the regions on the designated image as the reference region; and a start-up controller which selectively starts up the first setter and the second setter so that the first setter has priority over the second setter.

According to the present invention, a computer program embodied in a tangible medium, which is executed by a processor of an image processing apparatus, the program comprises: a first searching step of searching for, from a designated image, one or at least two first partial images each of which represents a face portion; a second searching step of searching for, from the designated image, one or at least two second partial images each of which represents a rear of a head in association with a searching process of the first searching step; a first setting step of setting a region corresponding to the one or at least two first partial images detected by the first searching step out of regions on the designated image as a reference region for an image quality adjustment; a second setting step of setting a region different from a region corresponding to the one or at least two second partial images detected by the second searching step out of the regions on the designated image as the reference region; and a start-up controlling step of selectively starting up the first setting step and the second setting step so that the first setting step has priority over the second setting step.

According to the present invention, an image processing method executed by an image processing apparatus, comprises: a first searching step of searching for, from a designated image, one or at least two first partial images each of which represents a face portion; a second searching step of searching for, from the designated image, one or at least two second partial images each of which represents a rear of a head in association with a searching process of the first searching step; a first setting step of setting a region corresponding to the one or at least two first partial images detected by the first searching step out of regions on the designated image as a reference region for an image quality adjustment; a second setting step of setting a region different from a region corresponding to the one or at least two second partial images detected by the second searching step out of the regions on the designated image as the reference region; and a start-up controlling step of selectively starting up the first setting step and the second setting step so that the first setting step has priority over the second setting step.

The above described features and advantages of the present invention will become more apparent from the following detailed description of the embodiment when taken in conjunction with the accompanying drawings.

### BRIEF DESCRIPTION OF THE DRAWINGS

FIG. 1 is a block diagram showing a basic configuration of one embodiment of the present invention;

FIG. 2 is a block diagram showing a configuration of one embodiment of the present invention;

FIG. 3 is an illustrative view showing one example of an allocation state of an evaluation area in an imaging surface;

FIG. 4 is an illustrative view showing one example of a face frame structure used in a face detection process;

FIG. 5 is an illustrative view showing one example of a configuration of a face dictionary referred to in the face detection process and a face portion/rear-of-a-head determining process;

FIG. 6 is an illustrative view showing one example of a human-body frame structure used in a human-body detecting process;

FIG. 7 is an illustrative view showing one example of a configuration of a human-body dictionary referred to in the human-body detecting process;

FIG. 8 is an illustrative view showing one portion of the face detection process and the human-body detecting process;

FIG. 9 is an illustrative view showing one example of a configuration of a register applied to the embodiment in FIG. 2;

FIG. 10 is an illustrative view showing one portion of behavior of the embodiment in FIG. 2;

FIG. 11 is an illustrative view showing one example of a head frame structure used in a head detecting process;

FIG. 12 is an illustrative view showing one example of a configuration of a head dictionary referred to in the head detecting process;

FIG. 13 is an illustrative view showing one example of a configuration of a rear-of-the-head dictionary referred to in the face portion/rear-of-the-head determining process;

FIG. 14 is an illustrative view showing another portion of behavior of the embodiment in FIG. 2;

FIG. 15 is an illustrative view showing still another portion of behavior of the embodiment in FIG. 2;

FIG. 16 (A) is an illustrative view showing one example of a positional relationship between the first dictionary image contained in the face dictionary and the face frame structure;

FIG. 16 (B) is an illustrative view showing one example of a positional relationship between the second dictionary image contained in the face dictionary and the face frame structure;

FIG. 16 (C) is an illustrative view showing one example of a positional relationship between the third dictionary image contained in the face dictionary and the face frame structure;

FIG. 16 (D) is an illustrative view showing one example of a positional relationship between the fourth dictionary image contained in the face dictionary and the face frame structure;

FIG. 16 (E) is an illustrative view showing one example of a positional relationship between the fifth dictionary image contained in the face dictionary and the face frame structure;

FIG. 17 is an illustrative view showing yet another portion of behavior of the embodiment in FIG. 2;

FIG. 18 is an illustrative view showing another portion of behavior of the embodiment in FIG. 2;

FIG. 19 is an illustrative view showing still another portion of behavior of the embodiment in FIG. 2;

FIG. 20 is an illustrative view showing yet another portion of behavior of the embodiment in FIG. 2;

FIG. 21 is an illustrative view showing one example of behavior adjusting a depth of field;

FIG. 22 is a flowchart showing one portion of behavior of a CPU applied to the embodiment in FIG. 2;

FIG. 23 is a flowchart showing another portion of behavior of the CPU applied to the embodiment in FIG. 2;

FIG. 24 is a flowchart showing still another portion of behavior of the CPU applied to the embodiment in FIG. 2;

FIG. 25 is a flowchart showing yet another portion of behavior of the CPU applied to the embodiment in FIG. 2;

FIG. 26 is a flowchart showing another portion of behavior of the CPU applied to the embodiment in FIG. 2;

FIG. 27 is a flowchart showing still another portion of behavior of the CPU applied to the embodiment in FIG. 2;

FIG. 28 is a flowchart showing yet another portion of behavior of the CPU applied to the embodiment in FIG. 2;

FIG. 29 is a flowchart showing another portion of behavior of the CPU applied to the embodiment in FIG. 2;

FIG. 30 is a flowchart showing still another portion of behavior of the CPU applied to the embodiment in FIG. 2;

FIG. 31 is a flowchart showing yet another portion of behavior of the CPU applied to the embodiment in FIG. 2;

FIG. 32 is a flowchart showing another portion of behavior of the CPU applied to the embodiment in FIG. 2;

FIG. 33 is a flowchart showing still another portion of behavior of the CPU applied to the embodiment in FIG. 2;

FIG. 34 is a flowchart showing yet another portion of behavior of the CPU applied to the embodiment in FIG. 2;

FIG. 35 is a flowchart showing another portion of behavior of the CPU applied to the embodiment in FIG. 2;

FIG. 36 is a flowchart showing still another portion of behavior of the CPU applied to the embodiment in FIG. 2;

FIG. 37 is a flowchart showing yet another portion of behavior of the CPU applied to the embodiment in FIG. 2;

FIG. 38 is a flowchart showing another portion of behavior of the CPU applied to the embodiment in FIG. 2;

FIG. 39 is a flowchart showing still another portion of behavior of the CPU applied to the embodiment in FIG. 2;

FIG. 40 is a flowchart showing yet another portion of behavior of the CPU applied to the embodiment in FIG. 2;

FIG. 41 is a flowchart showing another portion of behavior of the CPU applied to the embodiment in FIG. 2;

FIG. 42 is a flowchart showing still another portion of behavior of the CPU applied to the embodiment in FIG. 2; and

FIG. 43 is a block diagram showing a configuration of another embodiment of the present invention.

### DETAILED DESCRIPTION OF THE PREFERRED EMBODIMENTS

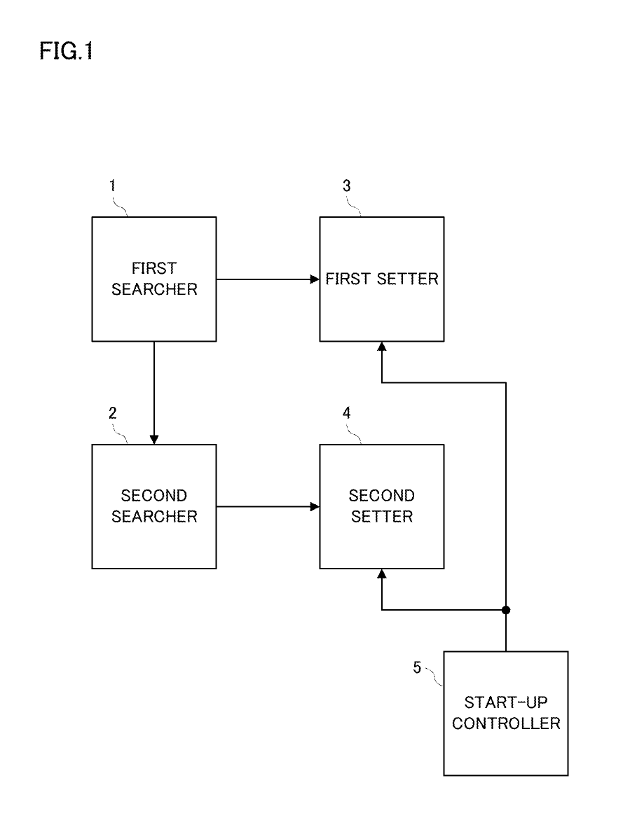

With reference to FIG. 1, an image processing apparatus according to one embodiment of the present invention is basically configured as follows: A first searcher 1 searches for, from a designated image, one or at least two first partial images each of which represents a face portion. A second searcher 2 searches for, from the designated image, one or at least two second partial images each of which represents a rear of a head in association with a searching process of the first searcher 1. A first setter 3 sets a region corresponding to the one or at least two first partial images detected by the first searcher 1 out of regions on the designated image as a reference region for an image quality adjustment. A second setter 4 sets a region different from a region corresponding to the one or at least two second partial images detected by the second searcher 2 out of the regions on the designated image as the reference region. A start-up controller 5 selectively starts up the first setter 3 and the second setter 4 so that the first setter 3 has priority over the second setter 4.

When both of a face portion image and a rear-of-the-head image are detected, or when only the face portion image is detected, a region corresponding to the face portion image is set as the reference region. On the other hand, when only the rear-of-the-head image is detected, a region different from a region corresponding to the rear-of-the-head image is set as the reference region. Since the reference region is a region for the image quality adjustment, an image quality is adjusted with reference to the face portion image when the face portion image is detected, and the image quality is adjusted with reference to an image different from the rear-of-the-head image when only the rear-of-the-head image is detected. Thereby, the image quality is improved.

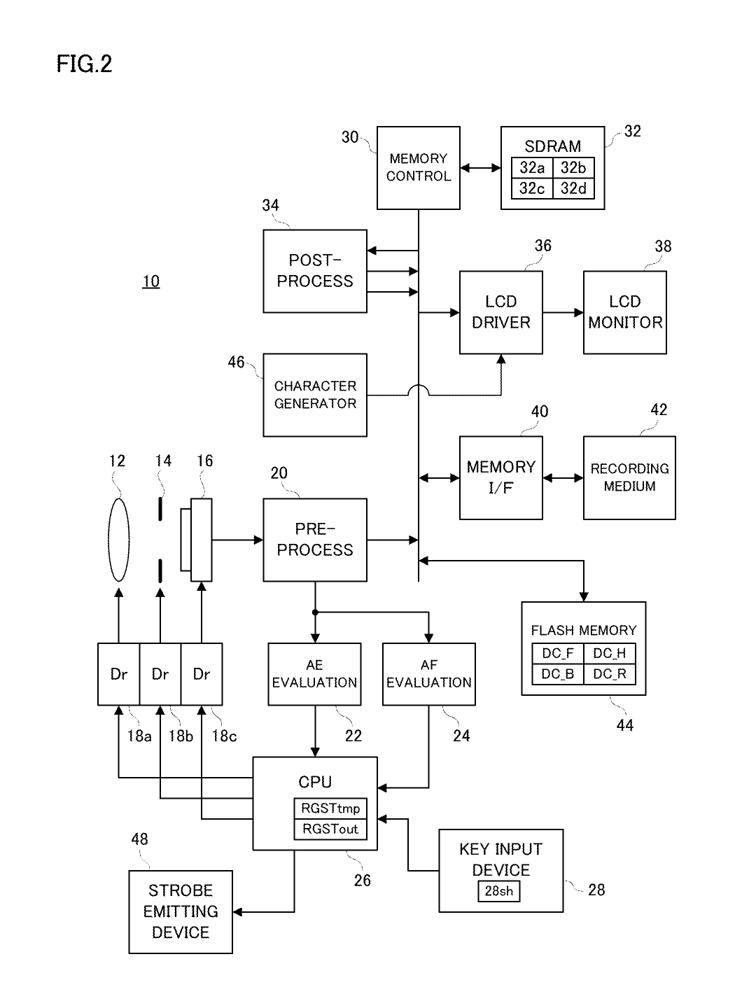

With reference to FIG. 2, a digital camera 10 according to one embodiment includes a focus lens 12 and an aperture unit 14 driven by drivers 18a and 18b, respectively. An optical image of a scene that underwent these components enters, with irradiation, an imaging surface of an imager 16, and is subjected to a photoelectric conversion. Thereby, electric charges representing a scene image are produced.

When a power source is applied, in order to execute a moving-image taking process, a CPU 26 commands a driver 18c to repeat an exposure procedure and an electric-charge reading-out procedure under the imaging task. In response to a vertical synchronization signal Vsync periodically generated from an SG (Signal Generator) not shown, the driver 18c exposes the imaging surface and reads out the electric charges produced on the imaging surface in a raster scanning manner. From the imager 16, raw image data that is based on the read-out electric charges is cyclically outputted.

A pre-processing circuit 20 performs processes, such as digital clamp, pixel defect correction, gain control and etc., on the raw image data outputted from the imager 16. The raw image data on which these processes are performed is written into a raw image area 32a of an SDRAM 32 through a memory control circuit 30.

A post-processing circuit 34 reads out the raw image data accommodated in the raw image area 32a through the memory control circuit 30, and performs a color separation process, a white balance adjusting process and a YUV converting process, on the read-out raw image data. Furthermore, the post-processing circuit 34 executes a zoom process for display and a zoom process for search to image data that comply with a YUV format, in a parallel manner. As a result, display image data and search image data that comply with the YUV format is individually created. The display image data is written into a display image area 32b of the SDRAM 32 by the memory control circuit 30. The search image data is written into a search image area 32c of the SDRAM 32 by the memory control circuit 30.

An LCD driver 36 repeatedly reads out the display image data accommodated in the display image area 32b through the memory control circuit 30, and drives an LCD monitor 38 based on the read-out image data. As a result, a real-time moving image (a live view image) of the scene is displayed on a monitor screen.

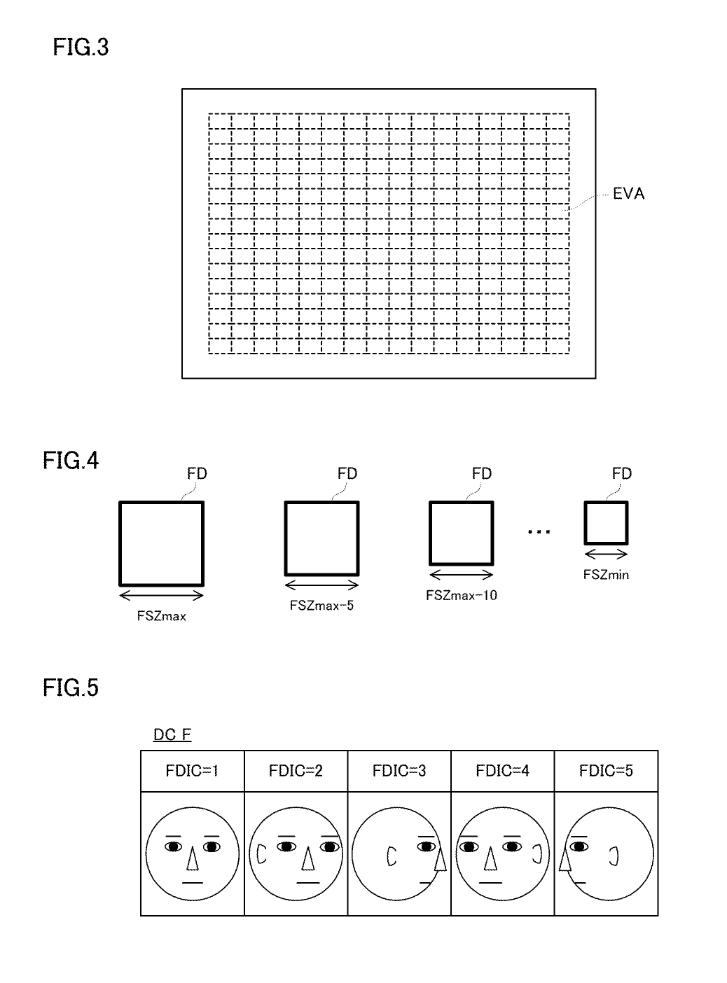

With reference to FIG. 3, an evaluation area EVA is allocated to a center of the imaging surface. The evaluation area EVA is divided into 16 portions in each of a horizontal direction and a vertical direction; therefore, 256 divided areas form the evaluation area EVA. Moreover, in addition to the above-described processes, the pre-processing circuit 20 shown in FIG. 2 executes a simple RGB converting process which simply converts the raw image data into RGB data.

An AE evaluating circuit 22 integrates RGB data belonging to the evaluation area EVA, out of the RGB data produced by the pre-processing circuit 20, at every time the vertical synchronization signal Vsync is generated. Thereby, 256 integral values (256 AE evaluation values) are outputted from the AE evaluating circuit 22 in response to the vertical synchronization signal Vsync. The AF evaluating circuit 24 integrates a high-frequency component of the RGB data belonging to the evaluation area EVA, out of the RGB data generated by the pre-processing circuit 20, at every time the vertical synchronization signal Vsync is generated. Thereby, 256 integral values (256 AF evaluation values) are outputted from the AF evaluating circuit 24 in response to the vertical synchronization signal Vsync. Processes based on thus obtained AE evaluation values and the AF evaluation values will be described later.

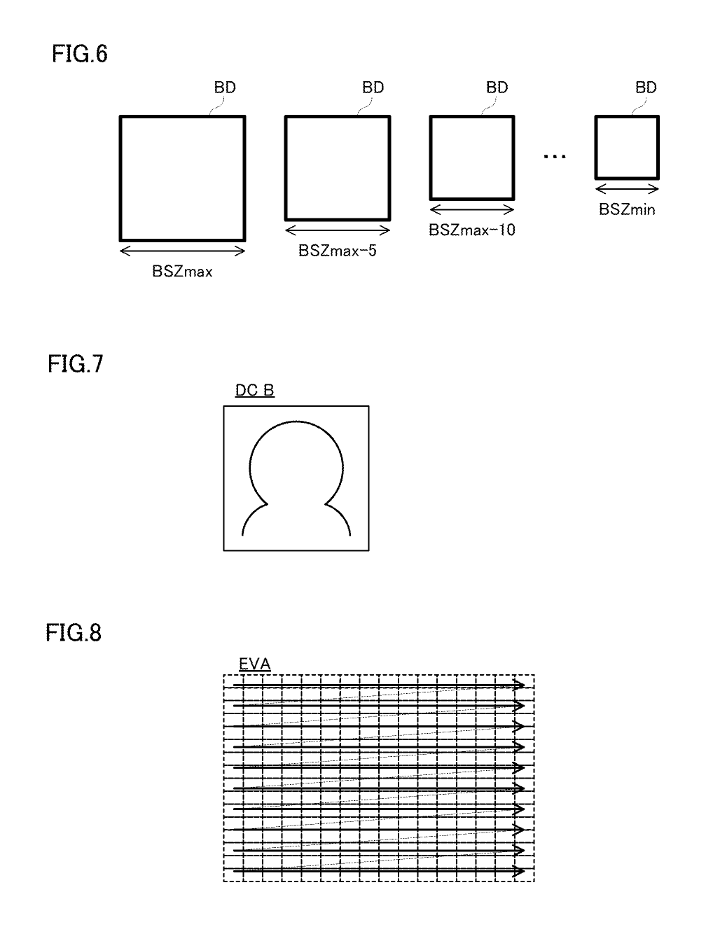

Under a person detecting task executed in parallel with the imaging task, the CPU 26 executes a face detecting process and a human-body detecting process in order to search for a face image of a person and a human-body image from the search image data accommodated in the search image area 32c, at every time the vertical synchronization signal Vsync is generated. In the face detecting process, a face frame structure FD of which a size is adjusted as shown in FIG. 4 and a face dictionary DC_F containing five dictionary images (=face images of which directions are mutually different) shown in FIG. 5 are used. Moreover, in the human-body detecting process, a human-body frame structure BD of which a size is adjusted as shown in FIG. 6 and a human-body dictionary DC_B containing a simple dictionary image (=an outline image of an upper body) shown in FIG. 7 are used. It is noted that both of the face dictionary DC_F and the human-body dictionary DC_B are stored in a flash memory 44.

In the face detecting process, the whole evaluation area EVA is set as a face portion search area, firstly. Moreover, in order to define a variable range of the size of the face frame structure FD, a maximum size FSZmax is set to “200”, and a minimum size FSZmin is set to “20”.

The face frame structure FD is moved by each predetermined amount in the raster scanning manner, from a start position (an upper left position) toward an ending position (a lower right position) of the face portion search area (see FIG. 8). Moreover, the size of the face frame structure FD is reduced by a scale of “5” from “FSZmax” to “FSZmin” at every time the face frame structure FD reaches the ending position.

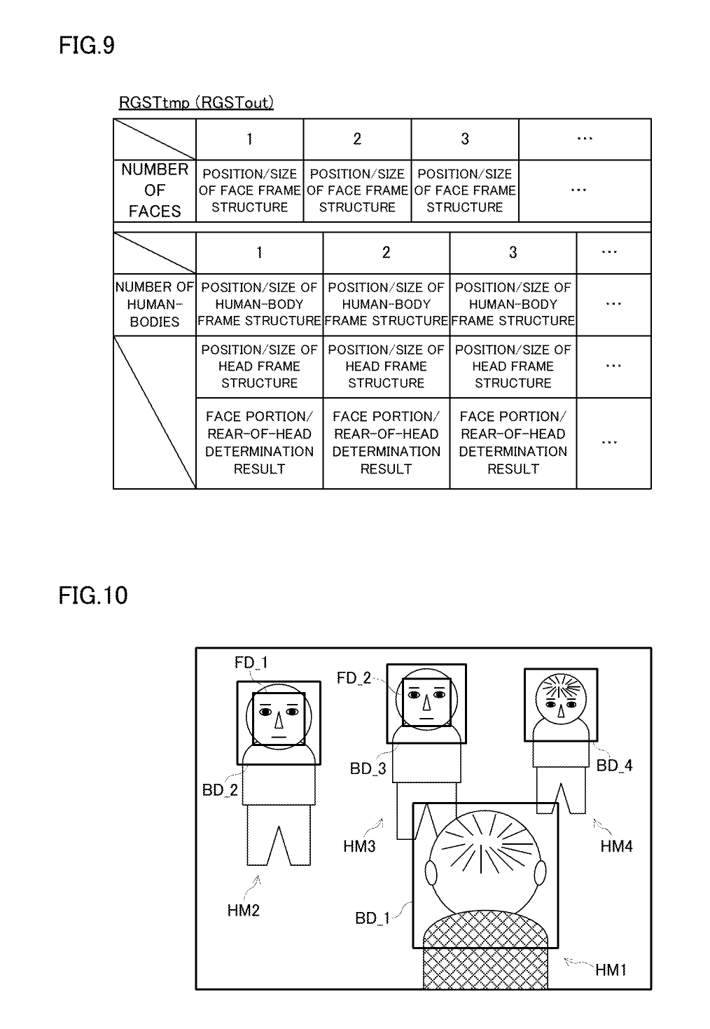

Partial search image data belonging to the face frame structure FD is read out from the search image area 32c through the memory control circuit 30. A characteristic amount of the read-out search image data is compared with a characteristic amount of each of the five dictionary images contained in the face dictionary DC_F. When a matching degree equal to or more than a threshold value TH_F is obtained, it is regarded that the face image has been detected. A position and a size of the face frame structure FD at a current time point are registered as face information in a register RGSTtmp shown in FIG. 9, and the number of faces described in the same register RGSTtmp is incremented along with a registration of the face information.

In the human-body detecting process, the whole evaluation area EVA is set as a human-body search area, firstly. Moreover, in order to define a variable range of the size of the human-body frame structure BD, a maximum size BSZmax is set to “400”, and a minimum size BSZmin is set to “40”.

The human-body frame structure BD is also moved by each predetermined amount in the raster scanning manner, from a start position (an upper left position) toward an ending position (a lower right position) of the human-body search area (see FIG. 8). Moreover, the size of the human-body frame structure BD is reduced by a scale of “5” from “BSZmax” to “BSZmin” at every time the human-body frame structure BD reaches the ending position.

Partial search image data belonging to the human-body frame structure BD is read out from the search image area 32c through the memory control circuit 30. A characteristic amount of the read-out search image data is compared with a characteristic amount of the dictionary image contained in the human-body dictionary DC_B. When a matching degree equal to or more than a threshold value TH_B is obtained, it is regarded that the human-body image is detected. A position and a size of the human-body frame structure BD at a current time point are registered as human-body information in the register RGSTtmp, and the number of human bodies described in the register RGSTtmp is incremented along with a registration of the human-body information.

Thus, when a person HM1 facing rearward against the imaging surface, persons HM2 and HM 3 facing the imaging surface and a person HM4 facing forward, obliquely downward against the imaging surface are captured as shown in FIG. 10, the face information registered in the register RGSTtmp indicates a position and a size of each of two face frame structures FD_1 and FD_2 shown in FIG. 10, and the number of the faces described in the register RGSTtmp indicates “2”. Moreover, the human-body information registered in the register RGSTtmp indicates a position and a size of each of four human-body frame structures BD_1 to BD_4 shown in FIG. 10, and the number of the human bodies described in the register RGSTtmp indicates “4”.

Upon completion of the human-body detecting process, under a human-body detecting task, the CPU 26 specifies the number of the human bodies described in the register RGSTtmp. If the specified number of the human bodies is equal to or more than “1”, the CPU 26 additionally executes a head detecting process and a face portion/rear-of-the-head determining process.

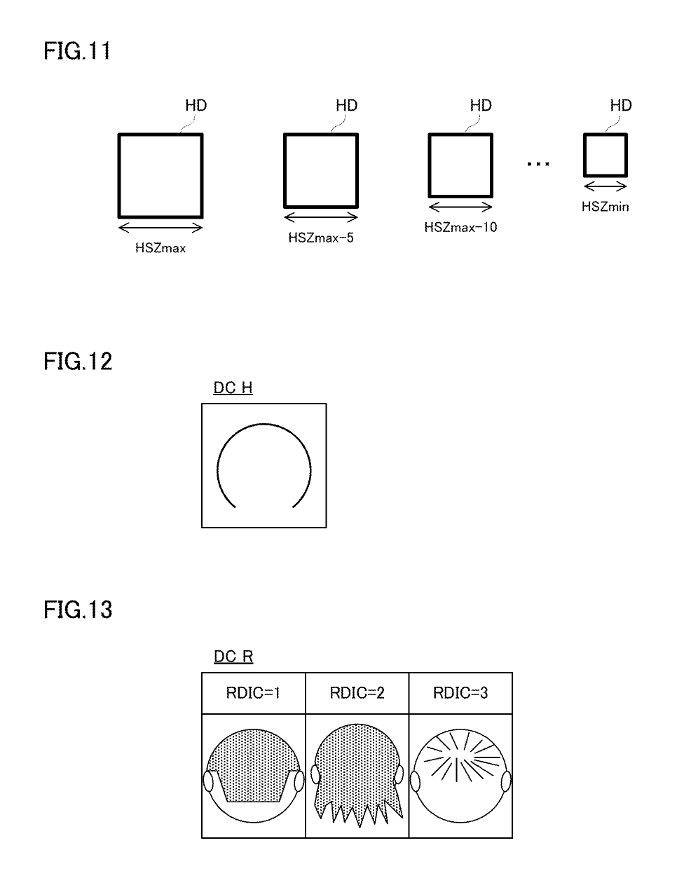

In the head detecting process, a head frame structure HD of which a size is adjusted as shown in FIG. 11 and a head dictionary DC_H containing a single dictionary image (=an outline image of the head) shown in FIG. 12 are used. Moreover, in the face portion/rear-of-the-head determining process, a rear-of-the-head dictionary DC_R containing three dictionary images (=rear-of-the-head images of which hairstyles are mutually different) as shown in FIG. 13 and the above-described face dictionary DC_F are used. It is noted that the head dictionary DC_H and the rear-of-the-head dictionary DC_R are also stored in the flash memory 44.

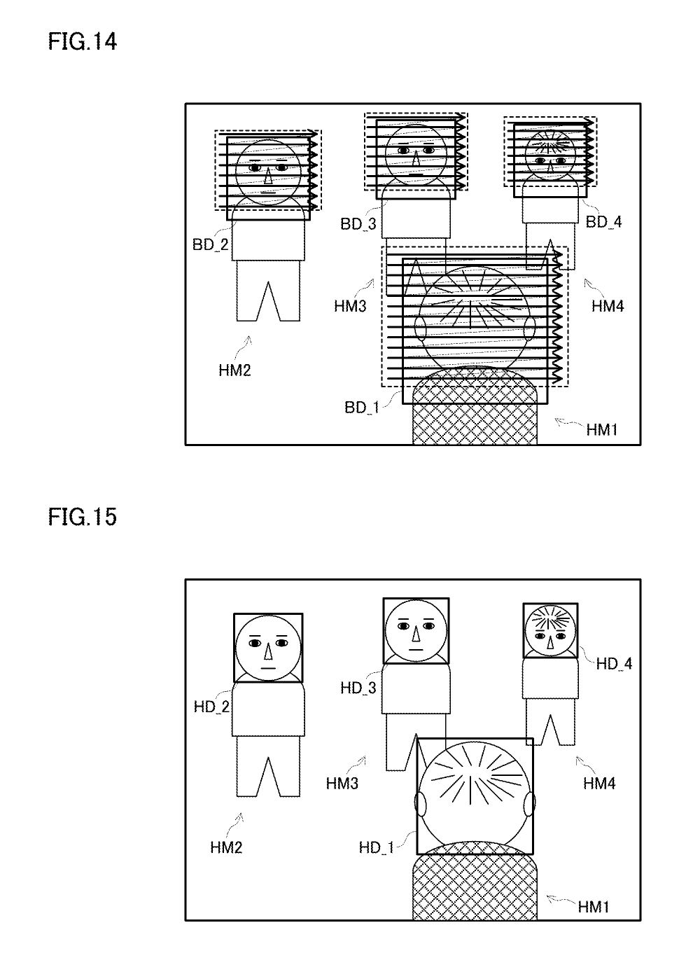

In the head detecting process, firstly, a variable BN equivalent to an identification number of the human-body information registered in the register RGSTtmp is set to “1”, and a BN-th human-body information is read out from the register RGSTtmp. A position and a size of the head are assumed based on the read-out human-body information. A head search area has a size larger than the assumed head size and is set to the assumed head position (see FIG. 14).

Subsequently, in order to define a variable range of the size of the head frame structure HD, a value that is 0.75 times a size defining the read-out human-body information is set as a maximum size HSZmax, and a value that is 0.6 times the size defining the read-out human-body information is set as a minimum size HSZmin.

The head frame structure HD is moved by each predetermined amount in the raster scanning manner, from a start position (an upper left position) toward an ending position (a lower right position) of the head search area. Moreover, the size of the head frame structure HD is reduced by a scale of “5” from “HSZmax” to “HSZmin” at every time the head frame structure HD reaches the ending position.

Partial search image data belonging to the head frame structure HD is read out from the search image area 32c through the memory control circuit 30. A characteristic amount of the read-out search image data is compared with a characteristic amount of the dictionary image contained in the head dictionary DC_H. When a matching degree equal to or more than a threshold value TH_H is obtained, it is regarded that the head image is detected, and a position and a size of the head frame structure HD at a current time point are registered as head information in the register RGSTtmp.

The variable BN is incremented at every time the head frame structure HD having the minimum size HSZmin reaches the ending position of the head search area. The above-described process is repeated until the variable BN exceeds the number of the human bodies described in the register RGSTtmp.

Thus, in an example shown in FIG. 10 or FIG. 14, a position and a size of each of four head frame structures HD_1 to HD_4 shown in FIG. 15 are registered as the head information in the register RGSTtmp.

In the face portion/rear-of-the-head determining process, firstly, the variable BN is set to “1”. If there is head information corresponding to the BN-th human-body information in the register RGSTtmp, face information common to the head information to be noticed is searched from the register RGSTtmp. Specifically, face information defining an area overlapped with an area defined by the head information to be noticed is searched for.

When desired face information is discovered, it is regarded that the face image is detected, and a face portion/rear-of-the-head determination result indicating “1” is registered corresponding to the BN-th human-body information in the register RGSTtmp. It is noted that the variable BN is incremented until exceeding the number of the human bodies described in the register RGSTtmp, at every time the face portion/rear-of-the-head determination result is registered in the register RGSTtmp.

Thus, in the example shown in FIG. 10, FIG. 14 or FIG. 15, the face portion/rear-of-the-head determination result indicates “1” corresponding to human-body information of the person HM2, and also indicates “1” corresponding to human-body information of the person HM3.

If the desired face information is not discovered, the head frame structure HD is set based on the head information to be noticed. The head frame structure HD has an area equivalent to the area defined by the head information, and is set to a position equivalent to a position defined by the head information.

The partial search image data belonging to the head frame structure HD is read out from the search image area 32c, and the characteristic amount of the read-out search image data is compared with a characteristic amount of each of the three dictionary images contained in the rear-of-the-head dictionary DC_R shown in FIG. 13. When a matching degree equal to or more than a threshold value TH_R is obtained, it is regarded that the rear-of-the-head image is detected, and a face portion/rear-of-the-head determination result indicating “2” is registered corresponding to the BN-th human-body information in the register RGSTtmp.

Thus, in the example shown in FIG. 10, FIG. 14 or FIG. 15, the face portion/rear-of-the-head determination result indicates “2” corresponding to human-body information of the person HM1.

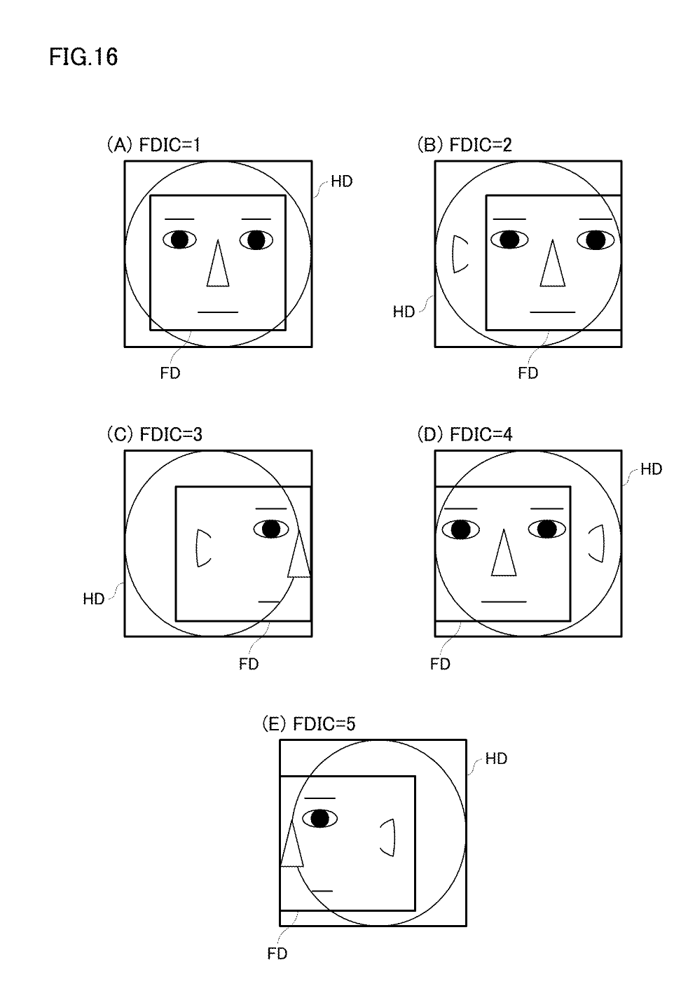

When the matching degree equal to or more than the threshold value TH_R is not obtained for any of the three dictionary images contained in the rear-of-the-head dictionary DC_R, each of the five dictionary images contained in the face dictionary DC_F is designated. The face frame structure FD is set to a position corresponding to a position of a face appeared in the designated dictionary image among the area defined by the head information to be noticed (see FIG. 16 (A) to FIG. 16 (E)).

Partial search image data belonging to the set face frame structure FD is read out from the search image area 32c, and a characteristic amount of the read-out search image data is compared with a characteristic amount of the designated dictionary image. If a matching degree is equal to or more than a threshold value TH_HF (here, TH_HF<TH_F), it is regarded that the face portion image may exist, and a face portion/rear-of-the-head determination result indicating “3” is registered corresponding to the BN-th human-body information in the register RGSTtmp.

Thus, in the example shown in FIG. 10, FIG. 14 or FIG. 15, if a matching degree between a face image belonging to a head frame structure HD_4 and the designated dictionary image is equal to or more than the threshold value TH_HF, the face portion/rear-of-the-head determination result indicates “3” corresponding to human-body information of the person HM4.

If the matching degree is less than the threshold value TH_HF with respect to any of the five dictionary images contained in the face dictionary DC_F, it is regarded that determining presence or absence of the face image is impossible, and a face portion/rear-of-the-head determination result indicating “4” is registered corresponding to the BN-th human-body information in the register RGSTtmp.

Thus, upon completion of the registration to the register RGSTtmp, the CPU 26 duplicates descriptions of the register RGSTtmp on a register RGSTout, and thereafter, the register RGSTtmp is cleared. A flag FLG_F referred to by the imaging task is updated as follows with reference to the descriptions of the register RGSTout.

If the number of faces described in the register RGSTout is equal to or more than “1”, in order to declare that the face portion image and/or the rear-of-the-head image exists on the search image data, the flag FLG_F is set to “1”. Moreover, even if the number of the faces described in the register RGSTout is “0”, the flag FLG_F is set to “1” if the number of human bodies described in the register RGSTout is equal to or more than “1” and at least one of the face portion/rear-of-the-head determination results described in the register RGSTout is “1”, “2” or “3”.

On the other hand, if any of the number of the faces and the number of the human bodies described in the register RGSTout is “0”, in order to declare that the face portion image and/or the rear-of-the-head image does not exist on the search image data, the flag FLG_F is set to “0”. Moreover, even if the number of the human bodies described in the register RGSTout is equal to or more than “1”, the flag FLG_F is set to “0” if any of the face portion/rear-of-the-head determination results described in the register RGSTout is “4”.

A state of the flag FLG_F thus set to “1” or “0” is repeatedly determined under the imaging task, and processes different depending on a determined result are executed as follows.

When the flag FLG_F indicates “1”, in order to display one or at least two face-frame-structure characters on the LCD monitor 38, the CPU 26 applies a face-frame-structure character display command to a character generator 46. The face-frame-structure character is displayed on the LCD monitor 38 in a manner according to face information registered in the register RGSTout. Upon completion of displaying, a noted region setting process, an AF area setting process, an AF process, an AE priority setting process, a strict AE process and a flash adjustment process are executed as follows.

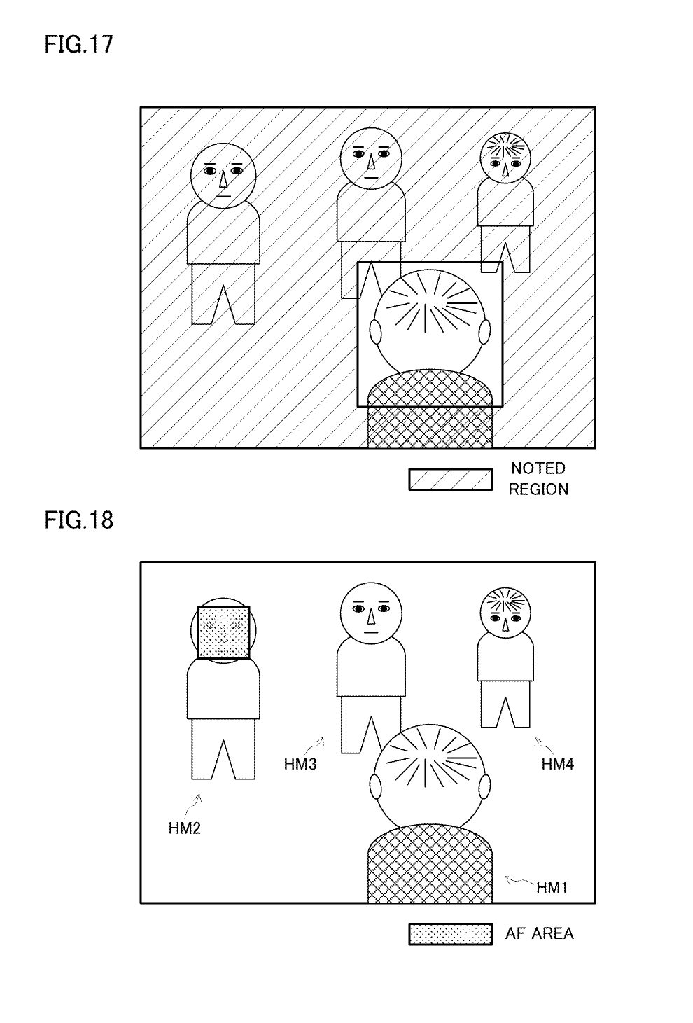

In the noted region setting process, firstly, the face portion/rear-of-the-head determination result indicating “2” is searched from the register RGSTout. Subsequently, a region of the person facing rearward against the imaging surface is specified based on the human-body information corresponding to the face portion/rear-of-the-head determination result indicating “2”. A noted region is set so as to avoid the specified person region. Thus, in the example shown in FIG. 10, FIG. 14 or FIG. 15, the noted region is set as shown in FIG. 17.

In the AF area setting process, an AF area is set as follows with reference to the descriptions of the register RGSTout.

If the number of faces described in the register RGSTout is equal to or more than “1”, face information defining a maximum size is specified from among the face information described in the register RGSTout. An AF area has a size equivalent to the size indicated by the specified face information and is set to a position indicated by the specified face information. Thus, in the example shown in FIG. 10, FIG. 14 or FIG. 15, the AF area is set to a position covering a face portion of the person HM2 as shown in FIG. 18.

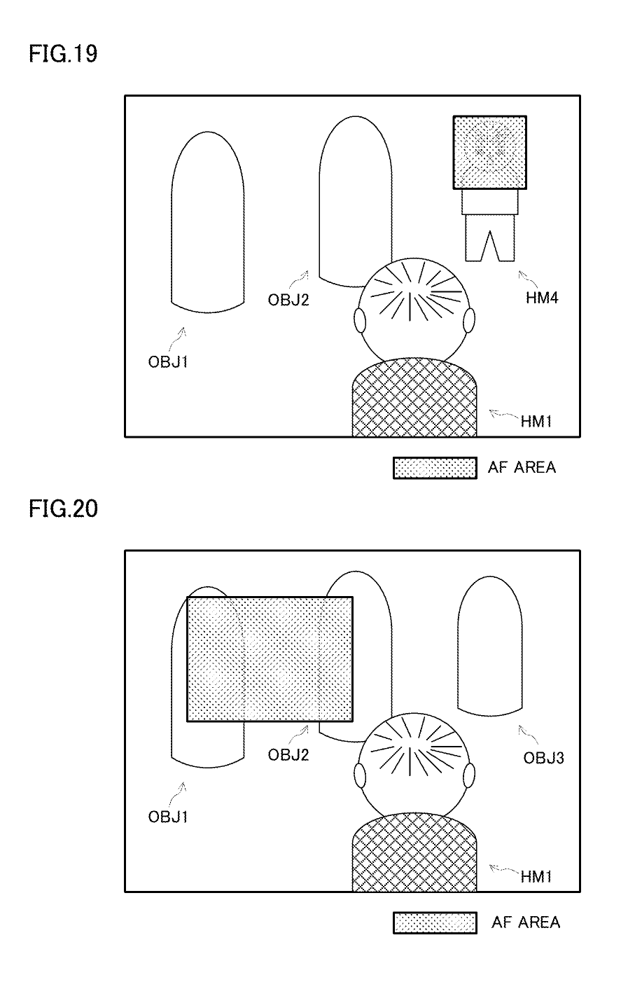

Even if the number of the faces described in the register RGSTout is “0”, human-body information defining a maximum size is specified from among the human-body information corresponding to the face portion/rear-of-the-head determination result indicating “3” if at least one of the one or at least two face portion/rear-of-the-head determination results described in the register RGSTout is “3”. The AF area has a size equivalent to the size indicated by the specified human-body information and is set to a position indicated by the specified human-body information. Thus, as shown in FIG. 19, when objects OBJ1 and OBJ2 exist instead of the persons HM2 and HM3, the AF area is set to a position covering an upper body of the person HM4.

If the number of the faces described in the register RGSTout is “0” and any of the one or at least two face portion/rear-of-the-head determination results described in the register RGSTout is “2”, the AF area is set within the noted region set by the noted region setting process. Thus, as shown in FIG. 20, when the objects OBJ1 to OBJ3 exist instead of the persons HM2 to HM 4, the AF area is set within the noted region.

The AF process is executed based on AF evaluation values belonging to the AF area set in an above-described manner, out of the 256 AF evaluation values outputted from the AF evaluating circuit 24. The focus lens 12 is moved in an optical-axis direction by the driver 18a and is set to a position in which the AF evaluation value to be noticed reaches a maximum. Thereby, a sharpness of an image belonging to the AF area is improved.

In the AE priority setting process, an AE adjusting procedure is set to any one of “aperture priority” and “exposure time priority”.

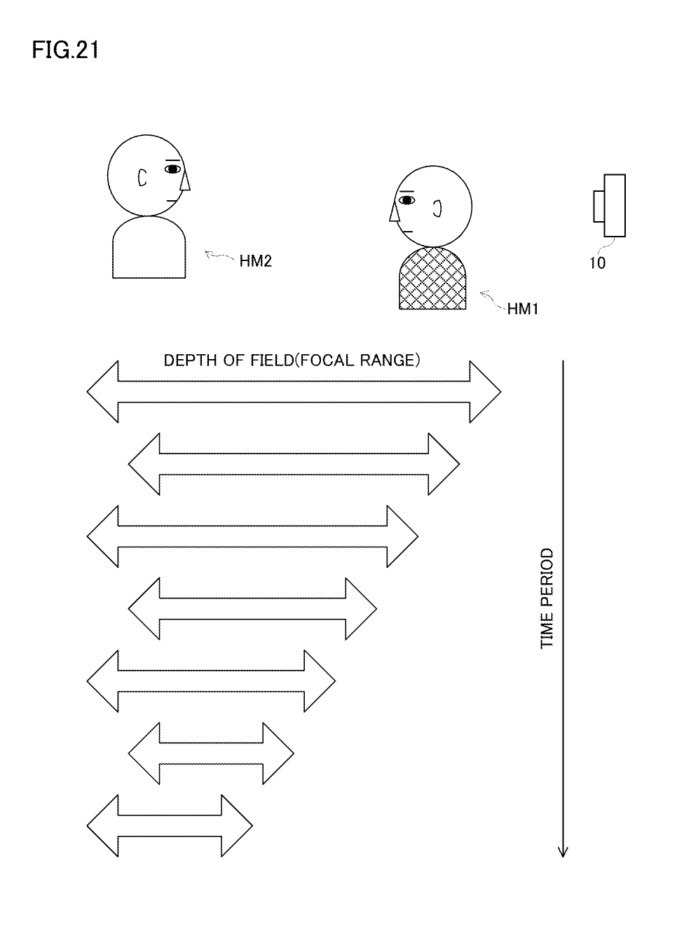

If the person facing rearward against the imaging surface exists and a degree of focus of the rear-of-the-head image (=an image defined by the head information corresponding to the face portion/rear-of-the-head determination result indicating “2”) is equal to or more than a threshold value Vaf1, a process of opening an aperture by each predetermined amount by driving the aperture unit 14 and the AF process referring to the AF evaluation values belonging to the AF area are executed in a parallel manner. Thereby, a depth of field is narrowed while focusing the image belonging to the AF area (see FIG. 21).

An AF adjusting procedure is set to the “aperture priority” at a time point at which the degree of focus of the rear-of-the-head image falls below the threshold value Vaf1 as a result of a change of the depth of field, or at a time point at which an opening amount of the aperture reaches a maximum value without the degree of focus of the rear-of-the-head image falling below the threshold value Vaf1. On the other hand, if the person facing rearward against the imaging surface does not exist, the AE adjusting procedure is set to the “exposure time priority”.

In the strict AE process, a photometry process is executed in a manner according to any one of photometric modes; “center-weighted photometry”, “face-priority photometry”, “human-body-priority photometry” and “multi photometry”.

When the “center-weighted photometry” is selected, an average value of a brightness of a center region in the scene is calculated as “Bav_ctr”, and concurrently, an average value of a brightness of a surrounding region (peripheral region) in the scene is calculated as “Bav_prf”, and then a BV value is calculated according to Equation 1.

BV value=0.9*Bav_{—}ctr+0.1*Bav_{—}prf [Equation 1]

When the “multi photometry” is selected, an average value of a brightness of the noted region set by the noted region setting process is calculated as “Bav_ntc” so as to calculate the BV value according to Equation 2.

BV value=Bav_{—}ntc [Equation 2]

When the “face-priority photometry” is selected in a state where the face portion of the person exists, an average value of a brightness of a face region (=the region defined by the face information) is calculated as “Bav_face”, and concurrently, the average value of the brightness of the noted region is calculated as “Bav_ntc”, and then the BV value is calculated according to Equation 3.

BV value=0.9*Bav_face+0.1*Bav_{—}ntc [Equation 3]

When the “human-body-priority photometry” is selected in a state where the face portion of the person exists, an average value of a brightness of a human-body region corresponding to the person facing the imaging surface (=a region defined by the human-body information corresponding to the face portion/rear-of-the-head determination result indicating “1”) is calculated as “Bav_bdy”, and concurrently, the average value of the brightness of the noted region is calculated as “Bav_ntc”, and then the BV value is calculated according to Equation 4.

BV value=0.9*Bav_{—}bdy+0.1*Bav_{—}ntc [Equation 4]

An aperture amount and an exposure time period are respectively set to the drivers 18b and 18c so as to be adapted to the calculated BV value and the AE priority setting. Thereby, a brightness of the live view image is adjusted to an appropriate value.

In the flash adjusting process, a direction and a light amount of a flash radiated from a strobe emitting device 48 are adjusted. The direction of the flash is adjusted to a standard direction when the person facing rearward against the imaging surface does not exist while is adjusted to a direction avoiding the rear of the head when the person facing rearward against the imaging surface exists. The light amount of the flash is adjusted to a standard amount when the face portion of the person does not exist while is adjusted to an amount based on the average value of the brightness of the face region when face portion of the person exists.

When the flag FLG_F indicates “0”, the CPU 26 applies a face-frame-structure character hiding command to the character generator 46. As a result, displaying the face-frame-structure character is cancelled. When displaying is cancelled, a simple AE process, the AE area setting process, the AF process and the flash adjustment process are executed as follows.

In the simple AE process, an appropriate BV value is calculated based on the 256 AE evaluation values outputted from the AE evaluating circuit 22. An aperture amount and an exposure time period adapted to the calculated appropriate BV value are respectively set to the drivers 18b and 18c, and thereby, the brightness of the live view image is adjusted to the appropriate value.

In the AE area setting process, the AF area is set to the center of the evaluation area EVA. The AF process is executed with reference to an AF evaluation value belonging to the set AF area. Thereby a sharpness of an image existing in the center of the evaluation area EVA is improved. In the flash adjusting process, the direction and the light amount of the flash radiated from the strobe emitting device 48 are respectively set to the standard direction and the standard amount.

When the shutter button 28sh is fully depressed via being half depressed, or is fully depressed at once, the CPU 26 executes a still-image taking process. As a result, the strobe emitting device 48 is driven as needed, and one frame of image data representing the scene at a time point at which the shutter button 28sh is fully depressed is taken into a still image area 32d. Upon completion of the still-image taking process, in order to execute a recording process, a memory I/F 40 is applied a corresponding command. The memory I/F 40 reads out the image data taken into the still image area 32d through the memory control circuit 30, and records the read-out image data on a recording medium 42 in a file format.

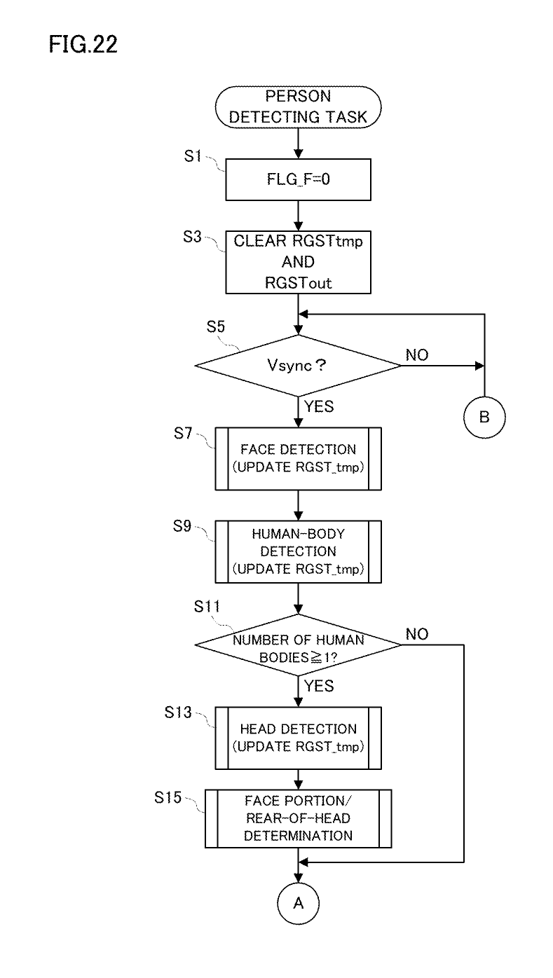

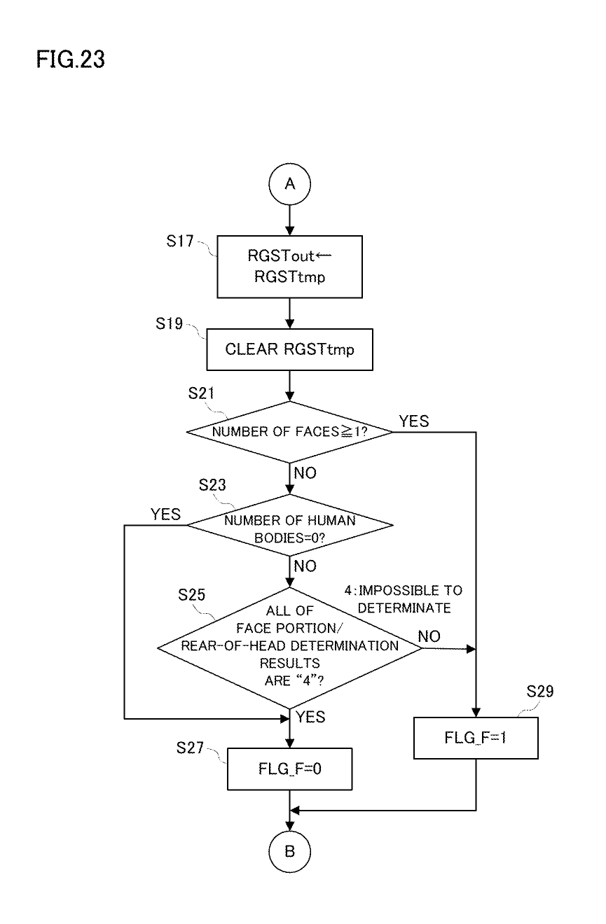

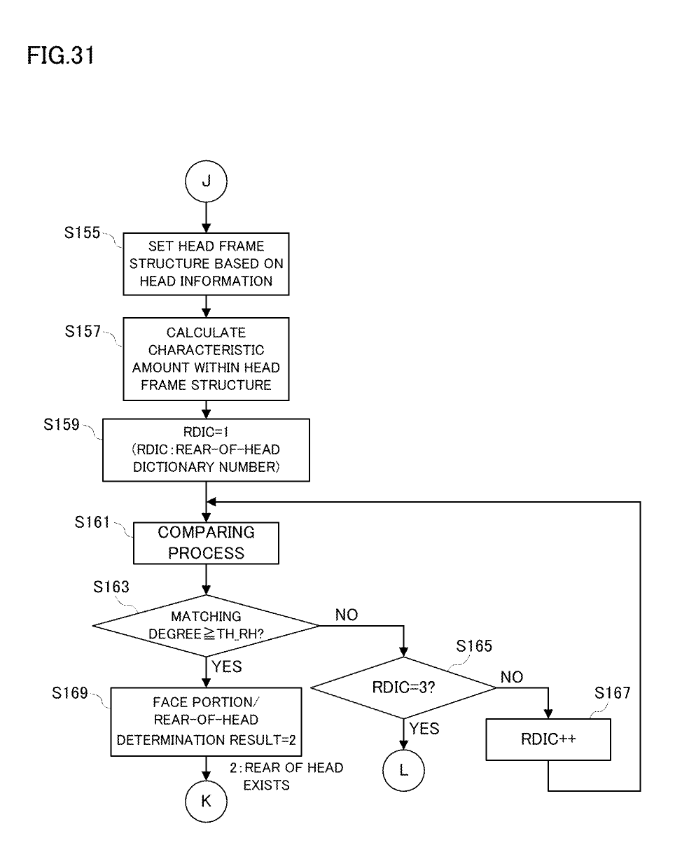

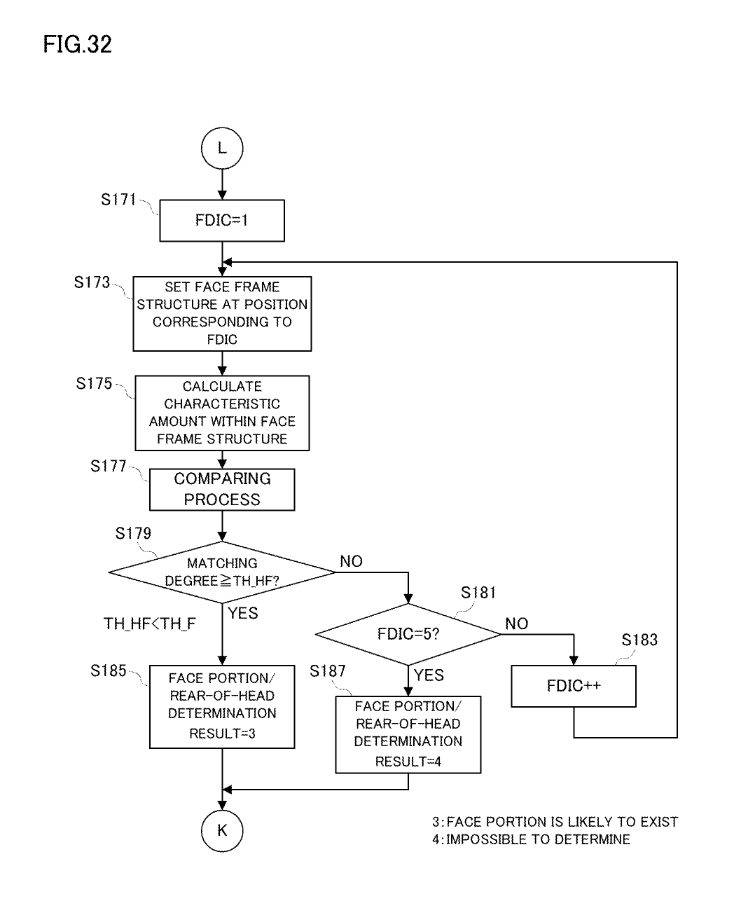

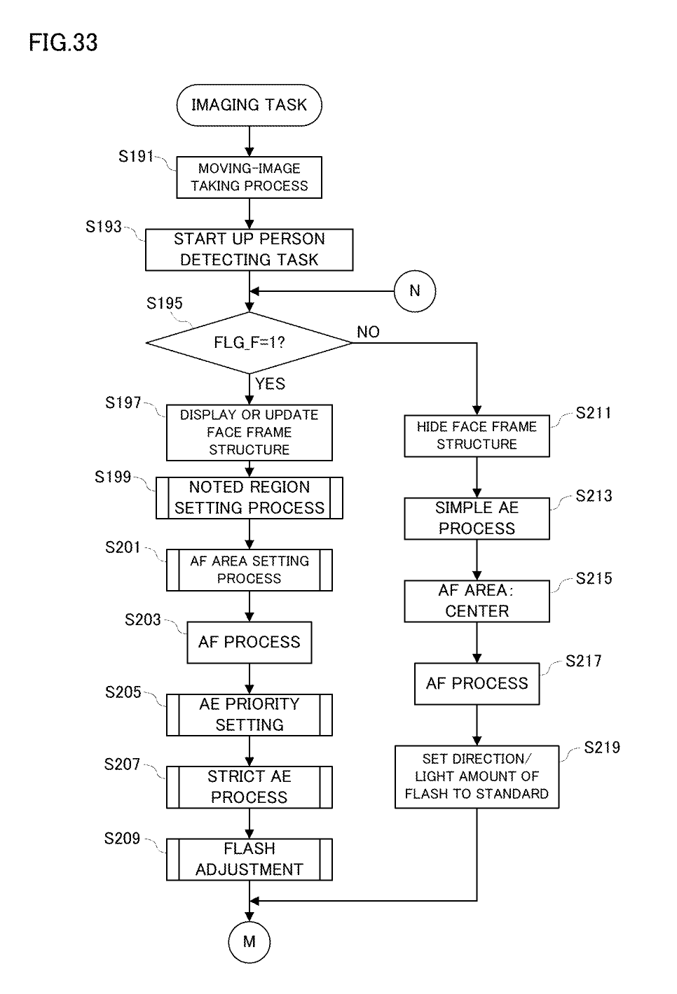

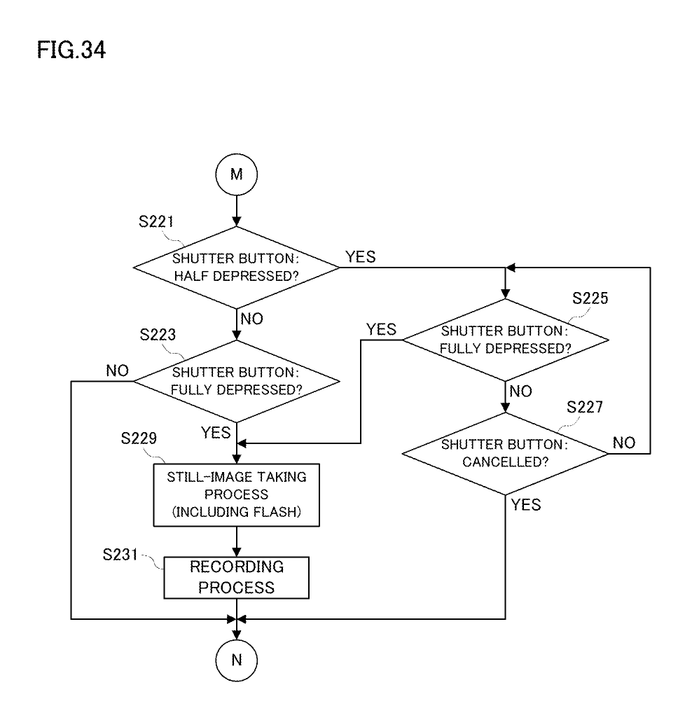

The CPU 26 executes, under a control of a multi task operating system, a plurality of tasks including the person detecting task shown in FIG. 22 to FIG. 32 and the imaging task shown in FIG. 33 to FIG. 42, in a parallel manner. It is noted that, control programs corresponding to these tasks are stored in the flash memory 44.

With reference to FIG. 22, in a step S1, the flag FLG_F is set to “0”, and in a step S3, the registers RGSTtmp and RGSTout are cleared. In a step S5, it is repeatedly determined whether or not the vertical synchronization signal Vsync is generated, and when a determined result is updated from NO to YES, in a step S7, the face detecting process is executed, and concurrently, in a step S9, the human-body detecting process is executed.

As a result of the face detecting process, a partial image coincident with any one of the five dictionary images contained in the face dictionary DC_F (=a partial image of which the matching degree is equal to or more than the threshold value TH_F) is detected as the face image. In the register RGSTtmp, the position and size of the face frame structure surrounding the detected face image are registered as the face information. Also in the register RGSTtmp, the number of the detected face images is registered as the number of the faces.

As a result of the human-body detecting process, a partial image coincident with the dictionary image contained in the human-body dictionary DC_B (=a partial image of which the matching degree is equal to or more than the threshold value TH_B) is detected as the human-body image. In the register RGSTtmp, the position and size of the human-body frame structure surrounding the detected human-body image are registered as the human-body information. Also in the register RGSTtmp, the number of the detected human-body images is registered as the number of the human bodies.

In a step S11, it is determined whether or not the number of the human bodies detected by the human-body detecting process is equal to or more than “1”. When a determined result is NO, the process directly advances to a step S17 while when the determined result is YES, in steps S13 and S15, the head detecting process and the face portion/rear-of-the-head determining process are executed, and thereafter, the process advances to the step S17.

As a result of the head detecting process, a partial image coincident with the dictionary image contained in the head dictionary DC_H (=a partial image of which the matching degree exceeds the threshold value TH_H) is detected as the head image. In the register RGSTtmp, the position and size of the head frame structure surrounding the detected head image are registered as the head information.

As a result of the face portion/rear-of-the-head determining process, an attribute of the head image detected by the head detecting process is determined. The face portion/rear-of-the-head determination result indicates “1” corresponding to the head image in which the face portion has appeared while indicates “2” corresponding to the head image in which the rear of the head has appeared. The face portion/rear-of-the-head determination result also indicates “3” corresponding to the head image in which the face portion may be appeared while indicates “4” corresponding to an impossibility of determining. These determined results are also registered in the register RGSTtmp.

In the step S17, the descriptions of the register RGSTtmp are duplicated on the register RGSTout, and in a step S19, the register RGSTtmp is cleared. In a step S21, it is determined whether or not the number of faces described in the register RGSTout is equal to or more than “1”, in a step S23, it is determined whether or not the number of human bodies described in the register RGSTout is “0”, and in a step S25, it is determined whether or not any of the face portion/rear-of-the-head determination results described in the register RGSTout is “4”.

When a determined result of the step S21 is YES, the process advances to a step S29. When the determined result of the step S21 is NO and a determined result of the step S23 is YES, the process advances to a step S27. When any of the determined results of the steps S21, S23 and S25 is NO, the process advances to the step S29. When the determined results of the steps S21 and S23 are NO and the determined result of the step S25 is YES, the process advances to the step S27.

In the step S27, in order to declare that the face portion image and/or the rear-of-the-head image does not exist on the search image data, the flag FLG_F is set to “0”. In the step S29, in order to declare that the face portion image and/or the rear-of-the-head image exists on the search image data, the flag FLG_F is set to “1”. Upon completion of the process in the step S27 or S29, the process returns to the step S5.

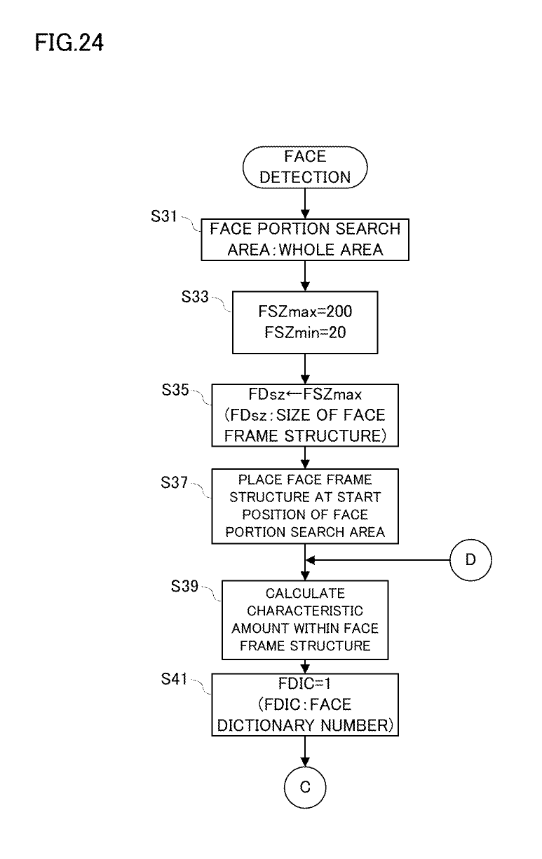

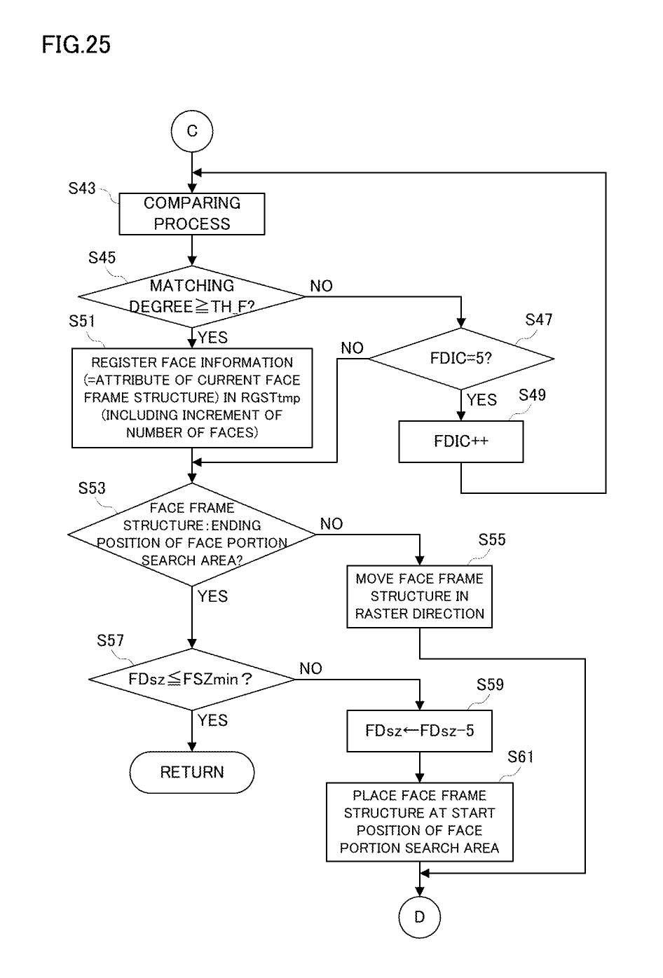

The face detecting process in the step S7 shown in FIG. 22 is executed according to a subroutine shown in FIG. 24 to FIG. 25.

Firstly, in a step S31, the whole evaluation area EVA is set as the face portion search area. In a step S33, in order to define the variable range of the size of the face frame structure FD, the maximum size FSZmax is set to “200”, and the minimum size FSZmin is set to “20”. Upon completion of defining the variable range, the process advances to a step S35 so as to set the size of the face frame structure FD to “FSZmax”.

In a step S37, the face frame structure FD is placed at the start position (the upper left position) of the face portion search area. In a step S39, the partial search image data belonging to the face frame structure FD is read out from the search image area 32c so as to calculate the characteristic amount of the read-out search image data. In a step S41, a face dictionary number FDIC is set to “1”.

In a step S43, the characteristic amount calculated in the step S39 is compared with the characteristic amount of the dictionary image corresponding to the face dictionary number FDIC out of the five dictionary images contained in the face dictionary DC_F. In a step S45, it is determined whether or not the matching degree is equal to or more than the threshold value TH_F, and in a step S47, it is determined whether or not the face dictionary number FDIC is “5”.

When a determined result of the step S45 is YES, the process advances to a step S51 so as to register the position and size of the face frame structure FD at the current time point as the face information in the register RGSTtmp. Also in the step S51, the number of the faces described in the register RGSTtmp is incremented. Upon completion of the process in the step S51, the process advances to a step S53.

When a determined result of the step S47 is YES, in a step S49, the face dictionary number FDIC is incremented, and thereafter, the process returns to the step S43. When both of the determined results of the steps S45 and S47 are NO, the process directly advances to the step S53.

In the step S53, it is determined whether or not the face frame structure FD reaches the ending position (the lower right position) of the face portion search area. When a determined result is NO, in a step S55, the face frame structure FD is moved by a predetermined amount in a raster direction, and thereafter, the process returns to the step S39. When the determined result is YES, in a step S57, it is determined whether or not the size of the face frame structure FD is equal to or less than “FSZmin”. When a determined result is NO, in a step S59, the size of the face frame structure FD is reduced by a scale of “5”, and in a step S61, the face frame structure FD is placed at the start position of the face portion search area. Thereafter, the process returns to the step S39. When the determined result of the step S57 is YES, the process returns to the routine in an upper hierarchy.

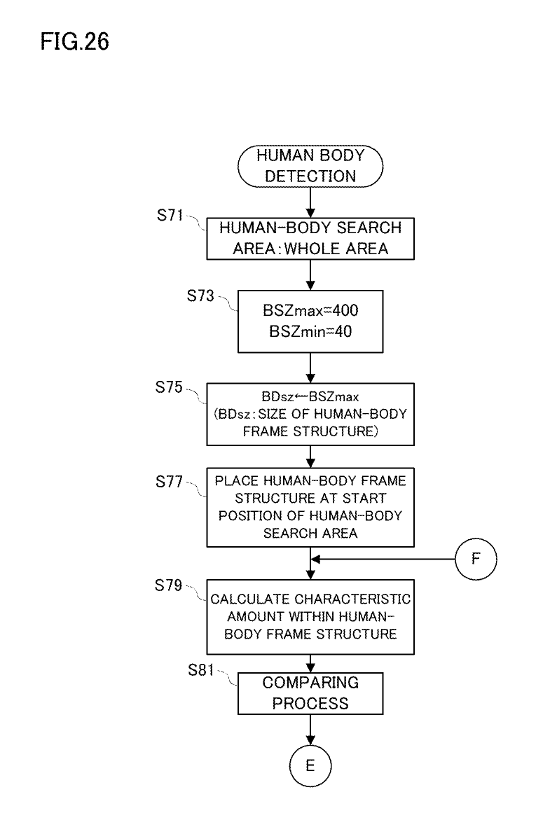

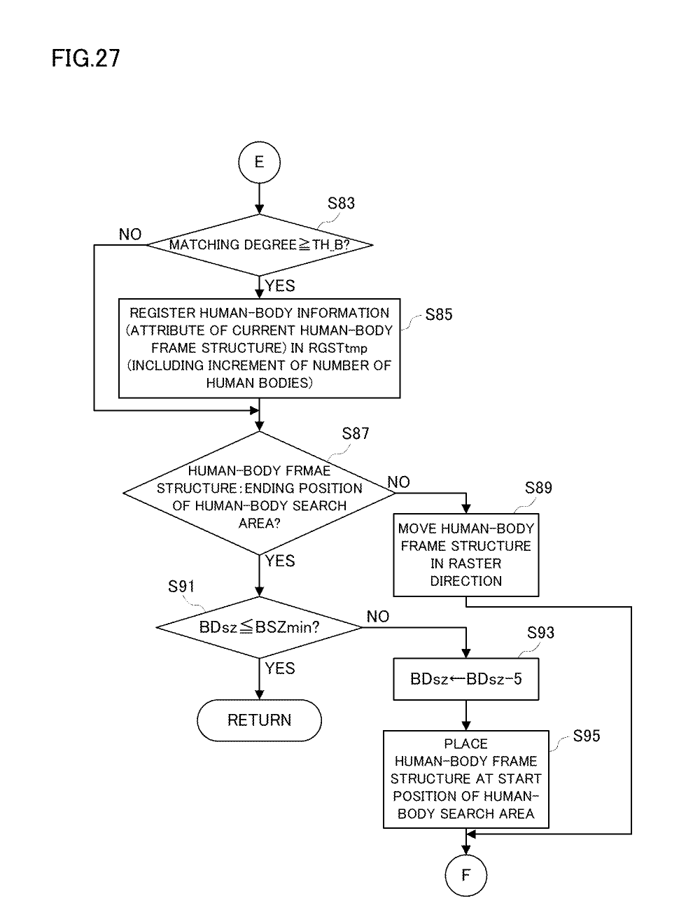

The human-body detecting process in the step S9 shown in FIG. 22 is executed according to a subroutine shown in FIG. 26 to FIG. 27.

Firstly, in a step S71, the whole evaluation area EVA is set as the human-body search area. In a step S73, in order to define the variable range of the size of the human-body frame structure BD, the maximum size BSZmax is set to “400”, and the minimum size BSZmin is set to “40”. Upon completion of defining the variable range, the process advances to a step S75 so as to set the size of the human-body frame structure BD to “BSZmax”.

In a step S77, the human-body frame structure BD is placed at the start position (the upper left position) of the human-body search area. In a step S79, the partial search image data belonging to the human-body frame structure BD is read out from the search image area 32c so as to calculate the characteristic amount of the read-out search image data. In a step S81, the characteristic amount calculated in the step S79 is compared with the characteristic amount of the dictionary image contained in the human-body dictionary DC_B.

In a step S83, it is determined whether or not the matching degree is equal to or more than the threshold value TH_B, and when a determined result is NO, the process directly advances to a step S87 while when the determined result is YES, the process advances to the step S87 via a process in a step S85. In the step S87, the position and size of the human-body frame structure BD at the current time point are registered as the human-body information in the register RGSTtmp. Also in the step S87, the number of the human bodies described in the register RGSTtmp is incremented.

In the step S87, it is determined whether or not the human-body frame structure BD reaches the ending position (the lower right position) of the human-body search area. When a determined result is NO, in a step S89, the human-body frame structure BD is moved by a predetermined amount in a raster direction, and thereafter, the process returns to the step S79. When the determined result is YES, in a step S91, it is determined whether or not the size of the human-body frame structure BD is equal to or less than “BSZmin”. When a determined result is NO, in a step S93, the size of the human-body frame structure BD is reduced by a scale of “5”, and in a step S95, the human-body frame structure BD is placed at the start position of the human-body search area. Thereafter, the process returns to the step S79. When the determined result of the step S91 is YES, the process returns to the routine in an upper hierarchy.

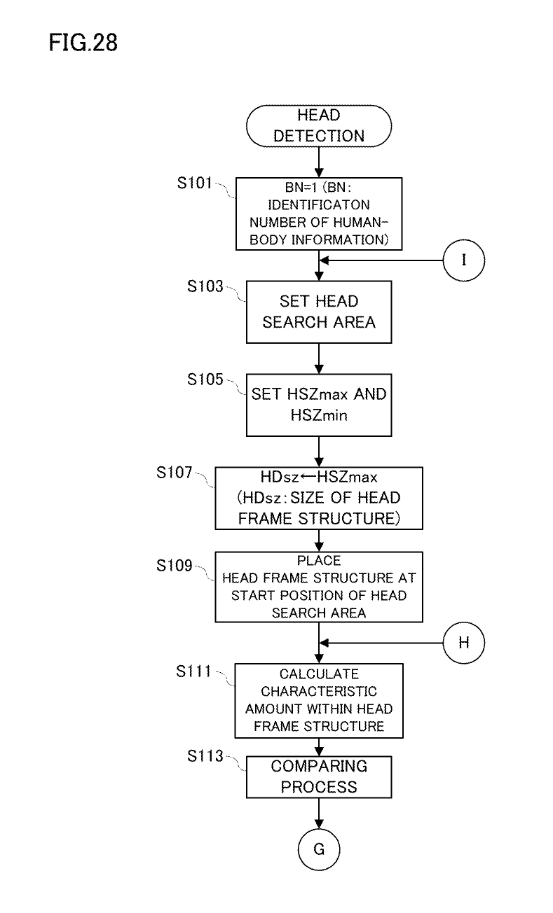

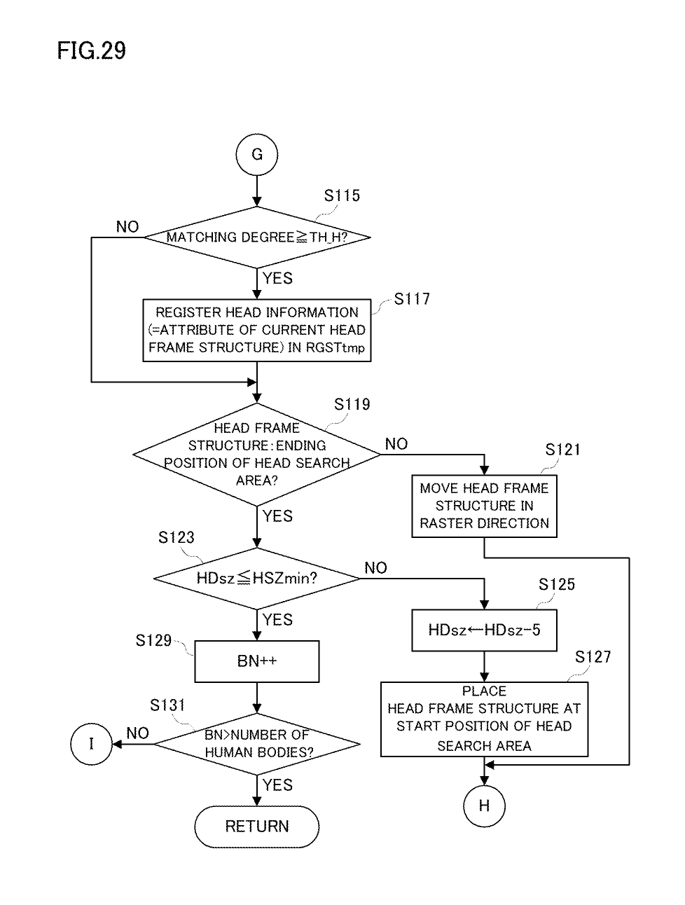

The head detecting process in the step S13 shown in FIG. 22 is executed according to a subroutine shown in FIG. 28 to FIG. 29.

Firstly, in a step S101, the variable BN equivalent to the identification number of the human-body information is set to “1”. In a step S103, the BN-th human-body information is read out from the register RGSTtmp, and the position and size of the head are assumed based on the read out human-body information so as to set the head search area having the size larger than the assumed head size to the assumed head position.

In a step S105, in order to define the variable range of the size of the head frame structure HD, the value that is 0.75 times the size defining the read out human-body information is set as the maximum size HSZmax, and the value that is 0.6 times the size defining the read out human-body information is set as the minimum size HSZmin. Upon completion of defining the variable range, the process advances to a step S107 so as to set the size of the head frame structure HD to “HSZmax”.

In a step S109, the head frame structure HD is placed at the start position (the upper left position) of the head search area. In a step S111, the partial search image data belonging to the head frame structure HD is read out from the search image area 32c so as to calculate the characteristic amount of the read-out search image data. In a step S113, the characteristic amount calculated in the step S111 is compared with the characteristic amount of the dictionary image contained in the head dictionary DC_H.

In a step S115, it is determined whether or not the matching degree is equal to or more than the threshold value TH_H, and when a determined result is NO, the process directly advances to a step S119 while when the determined result is YES, the process advances to the step S119 via a process in a step S117. In the step S117, the position and size of the head frame structure HD at the current time point are registered as the head information in the register RGSTtmp.

In the step S119, it is determined whether or not the head frame structure HD reaches the ending position (the lower right position) of the head search area. When a determined result is NO, in a step S121, the head frame structure HD is moved by a predetermined amount in a raster direction, and thereafter, the process returns to the step S111. When the determined result is YES, in a step S123, it is determined whether or not the size of the head frame structure HD is equal to or less than “HSZmin” When a determined result is NO, in a step S125, the size of the head frame structure HD is reduced by a scale of “5”, and in a step S127, the head frame structure HD is placed at the start position of the head search area. Thereafter, the process returns to the step S111.

When the determined result of the step S123 is YES, in a step S129, the variable BN is incremented, and in a step S131, it is determined whether or not the value of the incremented variable BN exceeds the number of human bodies described in the register RGSTtmp. When a determined result is NO, the process returns to the step S103 while when the determined result is YES, the process returns to the routine in an upper hierarchy.

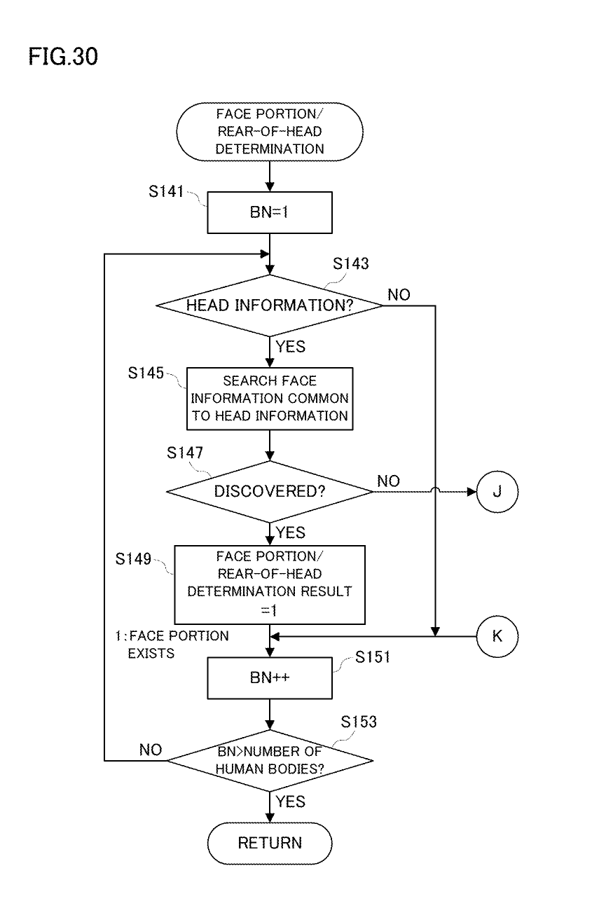

The face portion/rear-of-the-head determining process in the step S15 shown in FIG. 22 is executed according to a subroutine shown in FIG. 30 to FIG. 32.

Firstly, in a step S141, the variable BN is set to “1”. In a step S143, it is determined whether or not the head information corresponding to the BN-th human-body information exists in the register RGSTtmp, and when a determined result is YES, the process advances to a step S145 while when the determined result is NO, the process advances to a step S151.

In the step S145, the face information common to the head information to be noticed is searched from the register RGSTtmp. Specifically, the face information defining the area overlapped with the area defined by the head information to be noticed is searched for. In a step S147, it is determined whether or not the desired face information is discovered. When a determined result is YES, the process advances to a step S149 so as to register the face portion/rear-of-the-head determination result indicating “1” in the register RGSTtmp, corresponding to the BN-th human-body information. Upon completion of the registration, the process advances to the step S151.

In the step S151, the variable BN is incremented, and in a step S153, it is determined whether or not the value of the incremented variable BN exceeds the number of human bodies described in the register RGSTtmp. When a determined result is NO, the process returns to the step S143 while when the determined result is YES, the process returns to the routine in an upper hierarchy.

When the determined result of the step S147 is NO, the process advances to a step S155 so as to set the head frame structure HD based on the head information to be noticed. The head frame structure HD has the area equivalent to the area defined by the head information, and is set to the position equivalent to the position defined by the head information. In a step S157, the partial search image data belonging to the head frame structure HD is read out from the search image area 32c so as to calculate the characteristic amount of the read-out search image data.

In a step S159, a rear-of-the-head dictionary number RDIC is set to “1”. In a step S161, the characteristic amount calculated in the step S157 is compared with a characteristic amount of a dictionary image corresponding to the rear-of-the-head dictionary number RDIC out of the three dictionary images contained in the rear-of-the-head dictionary DC_R. In a step S163, it is determined whether or not the matching degree is equal to or more than the threshold value TH_R, and in a step S165, it is determined whether or not the rear-of-the-head dictionary number RDIC is “3”.

When a determined result of the step S163 is YES, the process advances to a step S169 so as to register the face portion/rear-of-the-head determination result indicating “2” in the register RGSTtmp, corresponding to the BN-th human-body information. Upon completion of the registration, the process advances to the step S151. When both of the determined results of the steps S163 and S165 are NO, in a step S167, the rear-of-the-head dictionary number RDIC is incremented, and thereafter, the process returns to the step S161. When the determined result of the step S163 is NO and the determined result of the step S165 is YES, the process advances to a step S171.

In the step S171, the face dictionary number FDIC is set to “1”. In a step S173, the face frame structure FD is set to a position and a size different depending on a value of the face dictionary number FDIC (=face direction) out of the area defined by the head information to be noticed. In a step S175, the partial search image data belonging to the set face frame structure FD is read out from the search image area 32c so as to calculate the characteristic amount of the read-out search image data.

In a step S177, the calculated characteristic amount is compared with the characteristic amount of the dictionary image corresponding to the face dictionary number FDIC. In a step S179, it is determined whether or not the matching degree is equal to or more than the threshold value TH_HF, and in a step S181, it is determined whether or not the face dictionary number FDIC is “5”. It is noted that the threshold value TH_HF is smaller than the above-described threshold value TH_F.

When both of the determined results of the steps S179 and S181 are NO, in a step S183, the face dictionary number FDIC is incremented, and thereafter, the process returns to the step S173. When the determined result of the step S179 is YES, the process advances to a step S185 while when the determined result of the step S179 is NO and the determined result of the step S181 is YES, the process advances to a step S187.

In the step S185, the face portion/rear-of-the-head determination result indicating “3” is registered corresponding to the BN-th human-body information in the register RGSTtmp. Moreover, in the step S187, the face portion/rear-of-the-head determination result indicating “4” is registered corresponding to the BN-th human-body information in the register RGSTtmp. Upon completion of the process in the step S185 or S187, the process advances to the step S151.

With reference to FIG. 33, in a step S191, a moving-image taking process is executed. As a result, the live view image representing the scene is displayed on the LCD monitor 38. In a step S193, the above-described person detecting task is started up, and in a step S195, it is determined whether or not the flag FLG_F indicates “1”. When FLG_F=1, the process advances to a step S221 via steps S197 to S209 while when FLG_F=0, the process advances to the step S221 via steps S211 to S219.

In the step S197, in order to display one or at least two face-frame-structure characters on the LCD monitor 38, the face-frame-structure character display command is applied to the character generator 46. The face frame character is displayed on the LCD monitor 38 in a manner according to the face information registered in the register RGSTout. In the step S199, the noted region setting process is executed, and in the step S201, the AF area setting process is executed.

In the noted region setting process, firstly, the face portion/rear-of-the-head determination result indicating “2” is searched from the register RGSTout. Subsequently, the region of the person facing rearward against the imaging surface is specified based on the human-body information corresponding to the face portion/rear-of-the-head determination result discovered from the register RGSTout. The noted region is set so as to avoid the specified person region.

In the AF area setting process, the AF area is set as follows with reference to the description of the register RGSTout.

If the number of the faces described in the register RGSTout is equal to or more than “1”, the face information defining the maximum size is specified from among the face information described in the register RGSTout. The AF area has the size equivalent to the size indicated by the specified face information and is set to the position indicated by the specified face information.

Even if the number of the faces described in the register RGSTout is “0”, the human-body information defining the maximum size is specified out of the human-body information corresponding to the face portion/rear-of-the-head determination result indicating “3” if at least one of the one or at least two face portion/rear-of-the-head determination results described in the register RGSTout is “3”. The AF area has the size equivalent to the size indicated by the specified human-body information and is set to the position indicated by the specified human-body information.

If the number of the faces described in the register RGSTout is “0” and any of the one or at least two face portion/rear-of-the-head determination results described in the register RGSTout is “2”, the AF area is set within the noted region set by the noted region setting process.

In the step S203, the AF process is executed, and in the step S205, the AE priority setting process is executed. Moreover, in the step S207, the strict AE process is executed, and in the step S209, the flash adjusting process is executed.

The AF process is executed based on the AF evaluation values belonging to the AF area set in the step S201, out of the 256 AF evaluation values outputted from the AF evaluating circuit 24. As a result, the focus is adjusted so that the sharpness of the image belonging to the AF area is improved.

In the AE priority setting process, the AE adjusting procedure is set to any one of “aperture priority” and “exposure time priority”.

If the person facing rearward against the imaging surface exists and the degree of focus of the rear-of-the-head image is equal to or more than the threshold value Vaf1, the process of opening the aperture by each predetermined amount and the AF process noticing the image belonging to the AF area are executed in a parallel manner. Thereby, the depth of field is narrowed while focusing the image belonging to the AF area.

The AF adjusting procedure is set to the “aperture priority” at the time point at which the degree of focus of the rear-of-the-head image falls below the threshold value Vaf1 as a result of the change of the depth of field, or at the time point at which the opening amount of the aperture reaches the maximum value without the degree of focus of the rear-of-the-head image falling below the threshold value Vaf1. On the other hand, if the person facing rearward against the imaging surface does not exist, the AE adjusting procedure is set to the “exposure time priority”.

In the strict AE process, the photometry process is executed in a manner according to any one of the photometric modes; “center-weighted photometry”, “face-priority photometry”, “human-body-priority photometry” and “multi photometry”.

When the “center-weighted photometry” is selected, the average value of the brightness of the center region and the average value of the brightness of the surrounding region are calculated so as to calculate the BV value based on these calculated average values. When the “multi photometry” is selected, the average value of the brightness of the noted region set by the noted region setting process is calculated so as to calculate the BV value based on the calculated average value.

When the “face-priority photometry” is selected in the state where the face portion of the person exists, the average value of the brightness of the face region and the average value of the brightness of the noted region are calculated so as to calculate the BV value based on these calculated average values. When the “human-body-priority photometry” is selected in the state where the face portion of the person exists, the average value of the brightness of the human-body region corresponding to the person facing the imaging surface and the average value of the brightness of the noted region are calculated so as to calculate the BV value based on these calculated average values.

An exposure amount (=the aperture amount and/or the exposure time period) is adjusted with reference to the calculated BV value. It is noted that an adjusting manner is according to the AE priority setting.

In the flash adjusting process, the direction and the light amount of the flash radiated from the strobe emitting device 48 are adjusted. The direction of the flash is adjusted to the standard direction when the person facing rearward against the imaging surface does not exist while is adjusted to the direction avoiding the rear of the head when the person facing rearward against the imaging surface exists. The light amount of the flash is adjusted to the standard amount when the face portion of the person does not exist while is adjusted to the amount based on the average value of the brightness of the face region when a face portion of the person exists.

In the step S211, the face-frame-structure character hiding command is applied to the character generator 46, and in the step S213, the simple AE process is executed. As a result of the process in the step S211, displaying the face-frame-structure character is cancelled. Moreover, as a result of the process in the step S213, the brightness of the live view image is adjusted appropriately. In the step S215, the AF area is set to the center of the evaluation area EVA, and in the step S217, the AF process similar to the step S203 is executed. In the step S219, the direction and the light amount of the flash radiated from the strobe emitting device 48 are respectively set to the standard direction and the standard amount.

In the step S221, it is determined whether or not the shutter button 28sh is half depressed, in each of steps S223 and S225, it is determined whether or not the shutter button 28sh is fully depressed, and in a step S227, it is determined whether or not the operation of the shutter button 28sh is cancelled.

When both of the determined results of the steps S221 and S223 are NO, or the determined results of the steps S221, S225 and S227 are respectively YES, NO and YES, the process directly returns to the step S195. Moreover, when the determined result of the step S227 is NO, the process returns to the step S225. Furthermore, when the determined result of the step S223 or S225 is YES, the process advances to a step S229 irrespective of the determined result of the step S221.

In the step S229, the still-image taking process is executed, and in a step S231, the recording process is executed. As a result of the process in the step S229, the strobe emitting device 48 is driven as needed, and one frame of the image data representing the scene at the time point at which the shutter button 28sh is fully depressed is taken into the still image area 32d. Moreover, as a result of the process in the step S231, the image data taken into the still image area 32d is recorded on the recording medium 42 in the file format. Upon completion of the process in the step S231, the process returns to the step S195.

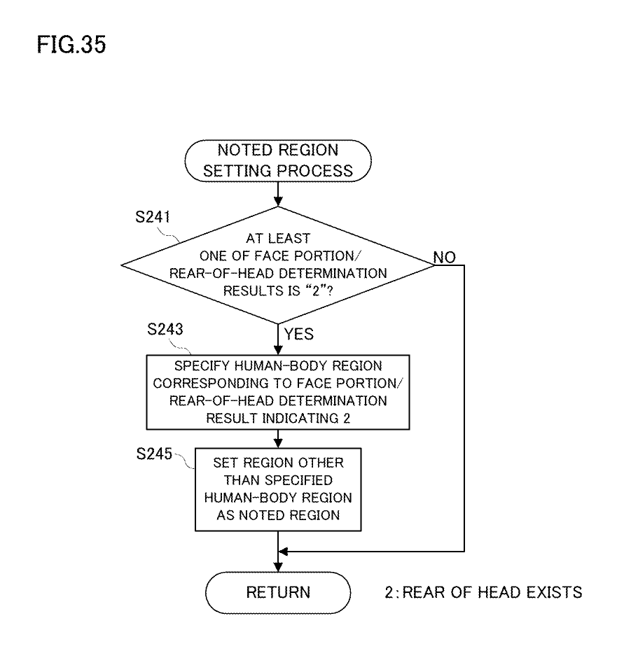

The noted region setting process in the step S199 shown in FIG. 33 is executed according to a subroutine shown in FIG. 35. In a step S241, it is determined whether or not at least one of the face portion/rear-of-the-head determination results described in the register RGSTout indicates “2”. When a determined result is NO, the process directly returns to the routine in an upper hierarchy while when the determined result is YES, the process advances to a step S243.

In the step S243, one or at least two regions in which one or at least two human-body images having the rear of the heads respectively exist are specified on the search image data. The region specifying process is executed with reference to the human-body information described in the register RGSTout, corresponding to the face portion/rear-of-the-head determination result indicating “2”. In a step S245, a simple region involving one or at least two regions specified in the step S243 is defined on the search image data so as to set a region other than the simple region thus defined, as the noted region. Upon completion of the setting, the process returns to the routine in an upper hierarchy.

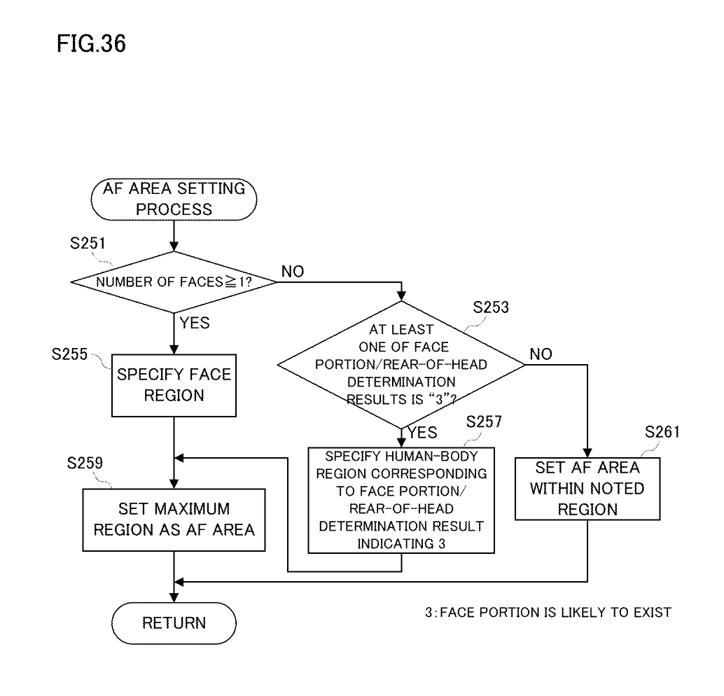

The AF area setting process in the step S201 shown in FIG. 33 is executed according to a subroutine shown in FIG. 36.

In a step S251, it is determined whether or not the number of the faces described in the register RGSTout is equal to or more than “1”, and in a step S253, it is determined whether or not at least one of the face portion/rear-of-the-head determination results described in the register RGSTout indicates “3”.

When a determined result of the step S251 is YES, the process advances to a step S255 so as to specify one or at least two regions in which one or at least two face images respectively exist, on the search image data. The region specifying process is executed with reference to the face information described in the register RGSTout.

When the determined result of the step S251 is NO and a determined result of the step S253 is YES, the process advances to a step S257 so as to specify one or at least two regions in which one or at least two human-body images respectively exist, on the search image data. The region specifying process is executed with reference to the human-body information described in the register RGSTout, corresponding to the face portion/rear-of-the-head determination result indicating “3”.

In a step S259, a region having a maximum size is extracted from among one or at least two regions specified in the step S255 or S257 so as to set the extracted region as the AF area. Upon completion of the setting process, the process returns to the routine in an upper hierarchy.

When both of the determined results of the steps S251 and S253 are NO, the process advances to a step S261 so as to set the AF area within the noted region. Upon completion of setting, the process returns to the routine in an upper hierarchy.

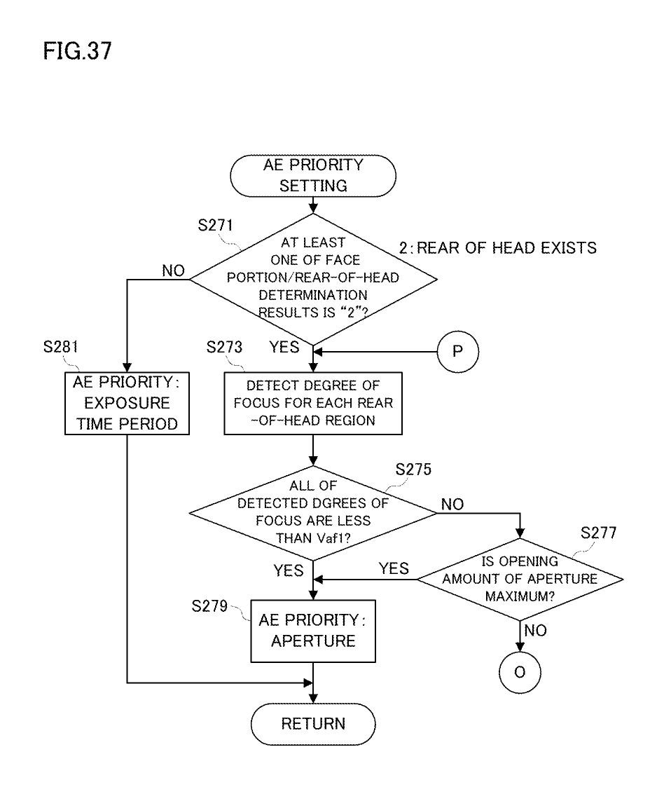

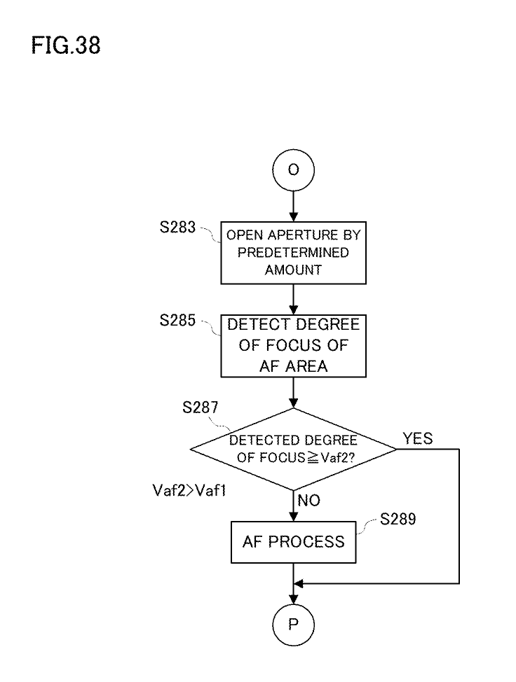

The AE priority setting process in the step S205 shown in FIG. 33 is executed according to a subroutine shown in FIG. 37 to FIG. 38.

In a step S271, it is determined whether or not at least one of the face portion/rear-of-the-head determination results described in the register RGSTout indicates “2”. When a determined result is NO, the process advances to a step S281 while when the determined result is YES, the process advances to a step S273. In the step S281, the AE adjusting procedure is set to the “exposure time priority”, and upon completion of the setting, the process returns to the routine in an upper hierarchy.

In the step S273, one or at least two head regions equivalent to the rear of the head are detected so as to detect the degree of focus for each detected head region. The head region is detected with reference to the human-body information corresponding to the face portion/rear-of-the-head determination result indicating “2”. Moreover, the degree of focus is detected with reference to an AF evaluation value belonging to the head region.

In a step S275, it is determined whether or not any of the detected one or at least two degrees of focus are less than the threshold value Vaf1, and in a step S277, it is determined whether or not the opening amount of the aperture is maximum. When any one of determined results of the steps S275 and S277 is YES, in a step S279, the AE adjusting procedure is set to the “aperture priority”. Upon completion of the setting, the process returns to the routine in an upper hierarchy.

When both of the determined results of the steps S275 and S277 are NO, the process advances to a step S283. In the step S283, the aperture unit 14 is driven so that the aperture is opened by a predetermined amount. In a step S285, the degree of focus of the image belonging to the AF area is detected with reference to the AF evaluation values belonging to the AF area out of the 256 AF evaluation values outputted from the AF evaluating circuit 24. In a step S287, it is determined whether or not the detected degree of focus is equal to or more than a threshold value Vaf2. Here, the threshold value Vaf2 is larger than the threshold value Vaf1. When a determined result is YES, the process directly returns to the step S273 while when the determined result is NO, in a step S289, the AF process similar to described above is executed, and thereafter, the process returns to the step S273.

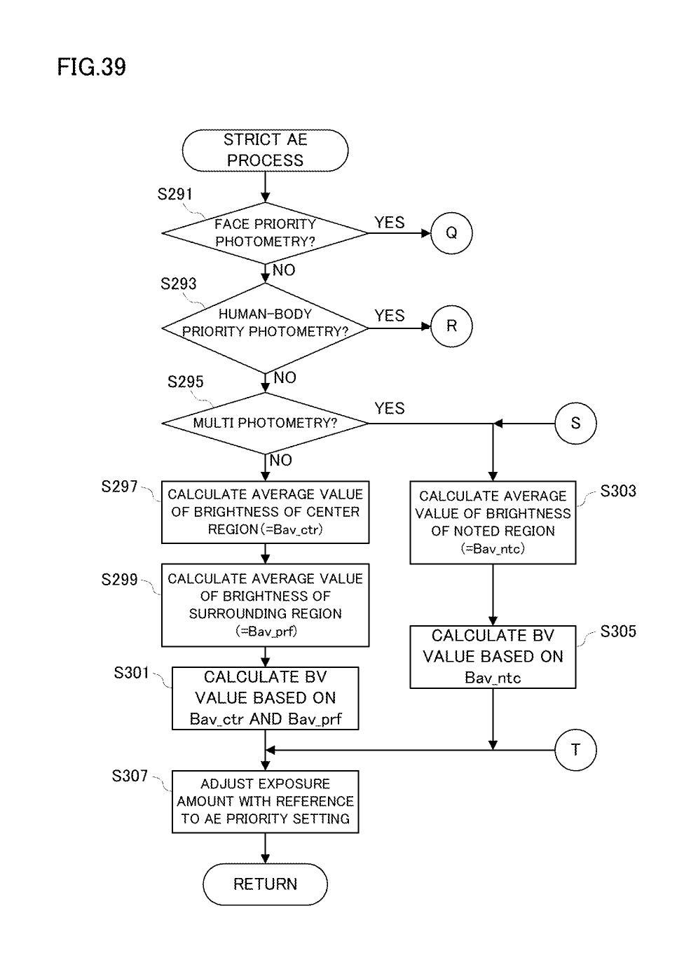

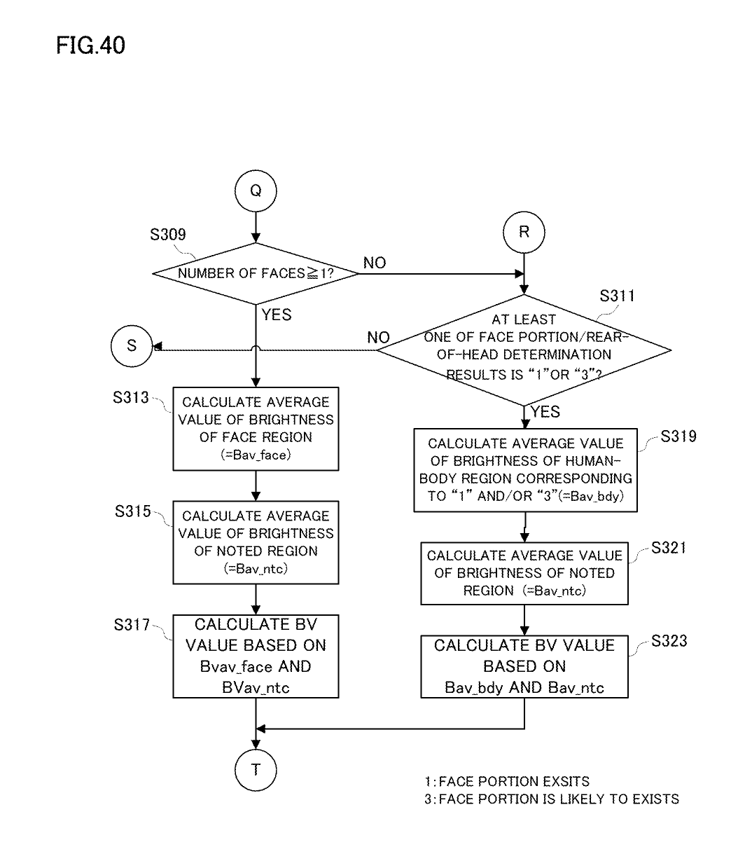

The strict AE process in the step S207 shown in FIG. 33 is executed according to a subroutine shown in FIG. 39 to FIG. 40.

Firstly, in steps S291, S293 and S295, it is determined whether the photometric mode at a current time point is any of “face-priority”, “human-body-priority”, “multi photometry” and “center-weighted photometry”. When the photometric mode at the current time point is the “center-weighted photometry”, the process advances to a step S297 while when the photometric mode at the current time point is the “multi photometry”, the process advances to a step S303.

In the step S297, the average value of the brightness of the center region is calculated as “Bav_ctr”, and in a step S299, the average value of the brightness of the surrounding region is calculated as “Bav_prf”. The average value Bav_ctr is calculated based on AE evaluation values belonging to the center region out of the 256 AE evaluation values outputted from the AE evaluating circuit 22. Moreover, the average value Bav_prf is calculated based on AE evaluation values belonging to the surrounding region out of the same 256 AE evaluation values. In a step S301, the BV value is calculated by applying the calculated average values Bav_ctr and Bav_prf to Equation 1.

In the step S303, the average value of the brightness of the noted region set by the noted region setting process is calculated as “Bav_ntc”. The average value Bav_ntc is also calculated based on AE evaluation values belonging to the noted region out of the above-described 256 AE evaluation values. In a step S305, the BV value is calculated by applying the calculated average value Bav_ntc to Equation 2.

When the photometric mode at the current time point is the “face-priority photometry”, in a step S309, it is determined whether or not the number of the faces described in the register RGSTout is equal to or more than “1”, and in a step S311, it is determined whether or not at least one of the one or at least two face portion/rear-of-the-head determination results described in the register RGSTout indicates “1” or “3”. Moreover, when the photometric mode at the current time point is the “human-body-priority photometry”, the determination process in the step S311 is executed.

When a determined result of the step S309 is YES, the process advances to a step S313 while when the determined result of the step S309 is NO, the process advances to the step S311. Moreover, when a determined result of the step S311 is YES, the process advances to a step S319 while when the determined result of the step S311 is NO, the process advances to the step S303.

In the step S313, the average value of the brightness of the face region is calculated as “Bav_face”, and in a step S315, the average value of the brightness of the noted region is calculated as “Bav_ntc”. The average value Bav_face is calculated based on AE evaluation values belonging to an area defined by the face information described in the register RGSTout out of the 256 AE evaluation values outputted from the AE evaluating circuit 22. Moreover, the average value Bav_ntc is calculated in the same manner as the above-described step S303. In a step S317, the BV value is calculated by applying thus calculated average values Bav_face and Bav_ntc to Equation 3.

In a step S319, the average value of the brightness of the area defined by the human-body information corresponding to the face portion/rear-of-the-head determination result indicating “1” and/or “3” is calculated as “Bav_bdy”. The average value Bav_bdy is calculated based on AE evaluation values belonging to the area to be noticed. In a step S321, the average value Bav_ntc is calculated in the same manner as the step S315. In a step S323, the BV value is calculated by applying thus calculated average values Bav_bdy and Bav_ntc to Equation 4.

Upon completion of the process in the step S301, S305, S317 or S323, the process advances to a step S307. In the step S307, the exposure amount (=the aperture amount and/or the exposure time period) is adjusted in a manner according to the AE priority setting with reference to the BV value calculated in the above-described manner. Upon completion of the adjustment, the process returns to the routine in an upper hierarchy.

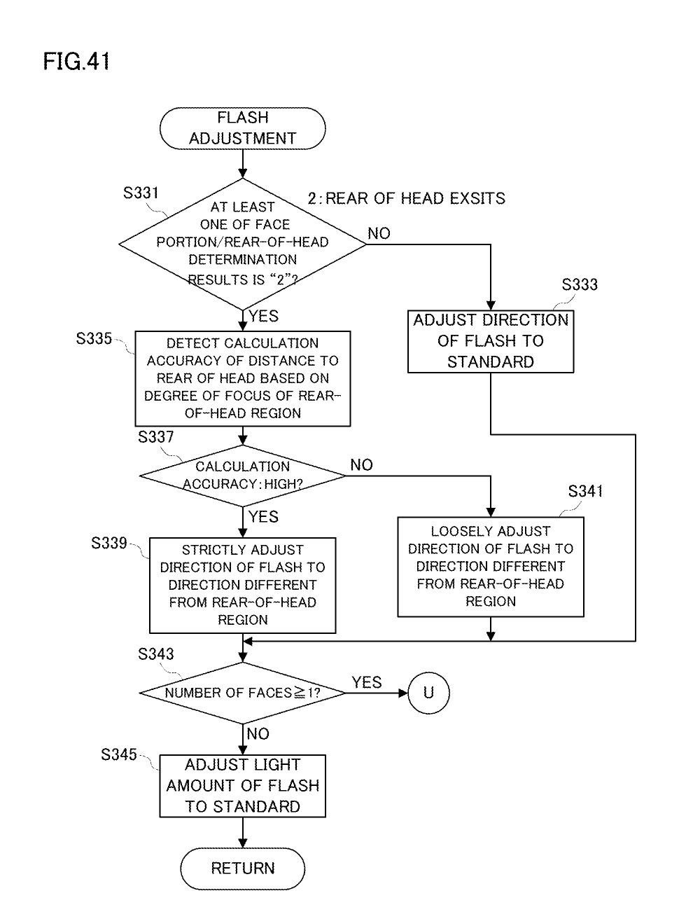

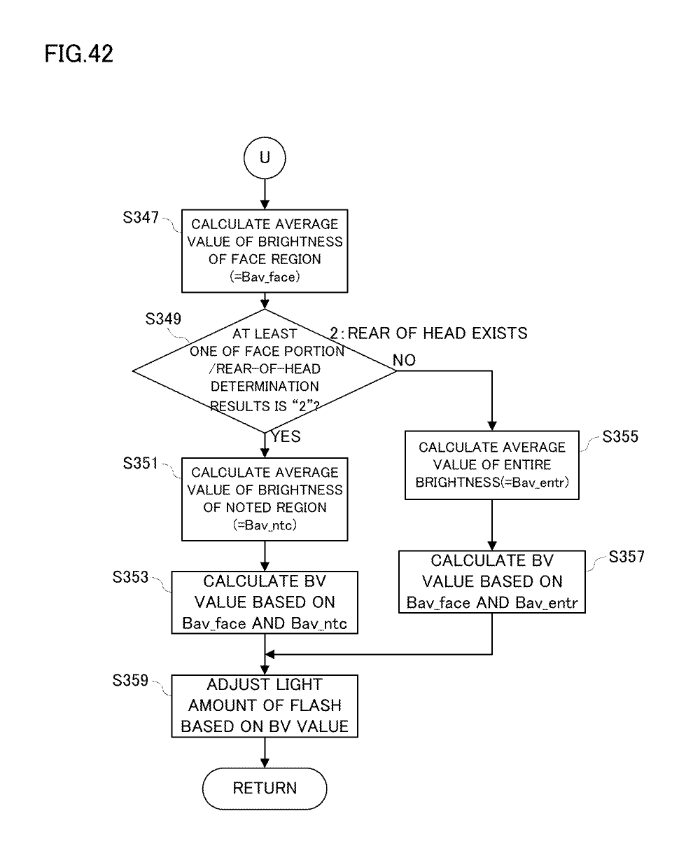

The flash adjusting process in the step S209 shown in FIG. 33 is executed according to a subroutine shown in FIG. 41 to FIG. 42.

Firstly, in a step S331, it is determined whether or not at least one of the one or at least two face portion/rear-of-the-head determination results described in the register RGSTout is “2”. When a determined result is NO, the process advances to a step S333 so as to adjust the direction of the flash radiated from the strobe emitting device 48 to a predetermined direction.

When the determined result of the step S331 is YES, the process advances to a step S335. In the step S335, the rear-of-the-head region is specified based on the head information corresponding to the face portion/rear-of-the-head determination result indicating “2”, and a calculation accuracy of a distance to the rear of the head is detected with reference to AF evaluation values belonging to the specified rear-of-the-head region. The calculation accuracy is increased according to an increase in the AF evaluation values to be noticed.

In a step S337, it is determined whether or not the detected calculation accuracy exceeds a reference, and when a determined result is YES, the process advances to a step S339 while when the determined result is NO, the process advances to a step S341. In the step S339, the direction of the flash is strictly adjusted to a direction different from the rear-of-the-head region. In the step S341, the direction of the flash is loosely adjusted to the direction different from the rear-of-the-head region.

Upon completion of the process in the step S333, S339 or S341, in a step S343, it is determined whether or not the number of the faces described in the register RGSTout is equal to or more than “1”. When a determined result is NO, the process advances to a step S345 so as to adjust the light amount of the flash to the standard amount. Upon completion of the adjustment, the process returns to the routine in an upper hierarchy.

When the determined result of the step S343 is YES, the process advances to a step S347 so as to calculate the average value Bav_face in the same manner as the above-described step S313. In a step S349, the determining process similar to the step S331 is executed, and when a determined result is YES, the process advances to a step S359 via processes in steps S351 to S353 while when the determined result is NO, the process advances to the step S359 via processes in steps S355 to S357.

In the steps S351 to S353, the BV value is calculated by the processes similar to the above-described steps S315 to S317. In the step S355, an average value of the 256 AE evaluation values outputted from the AE evaluating circuit 22 is calculated as “Bav_entr”, and in the step S357, the BV value is calculated based on the average values Bav_face and Bav_entr. In the step S359, the light amount of the flash is adjusted based on the calculated BV value. Upon completion of the adjustment, the process returns to the routine in an upper hierarchy.

As can be seen from the above-described explanation, the search image data represents the scene captured by the imager 16 and is accommodated in the search image area 32c of the SDRAM 32. The CPU 26 searches for one or at least two face portion images from the search image data (S7, S145 to S149 S171 to S185), and in parallel therewith, searches for one or at least two rear-of-the-head images from the same search image data (S155 to S169). Moreover, the CPU 26 selectively executes the process of setting the region corresponding to the one or at least two face portion images as the AF area (S255 to S259) and the process of setting the region different from the region corresponding to the one or at least two rear-of-the-head images as the AF area (S241 to S245, S261). Here, the former AF area setting process is started up prior to the latter AF area setting process.

Thus, when both of the face portion image and the rear-of-the-head image are detected, or when only the face portion image is detected, the region corresponding to the face portion image is set as the AF area. On the other hand, when only the rear-of-the-head image is detected, the region different from the region corresponding to the rear-of-the-head image is set as the AF area. When the face portion image is detected, the focus is adjusted with reference to the face portion image, and when only the rear-of-the-head image is detected, the focus is adjusted with reference to the image different from the rear-of-the-head image. Thereby, the image quality is improved.

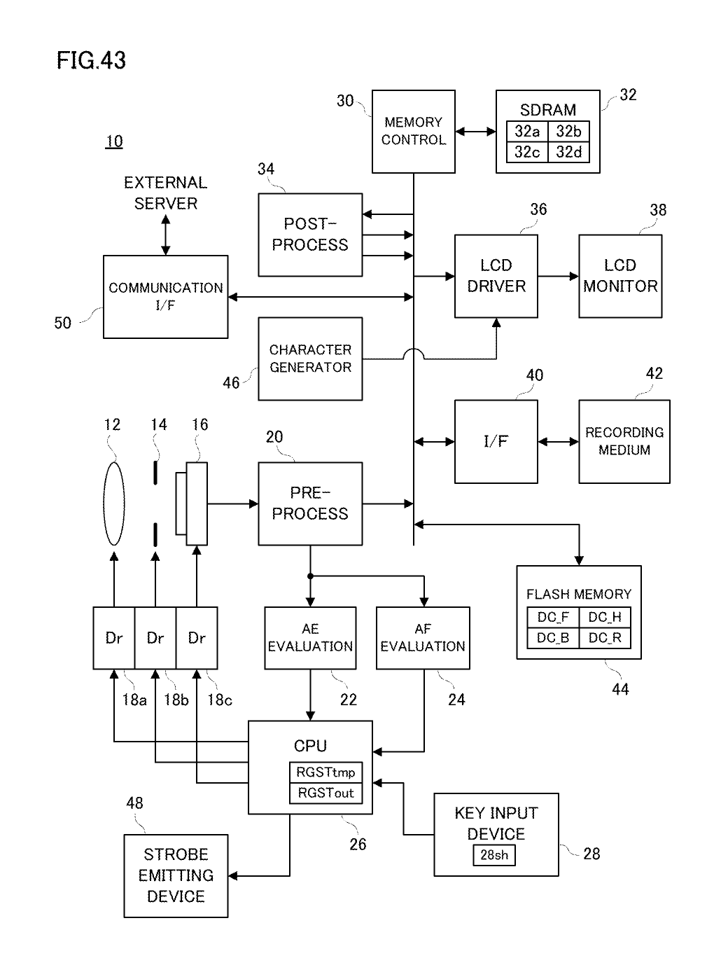

It is noted that, in this embodiment, the control programs equivalent to the multi task operating system and the plurality of tasks executed thereby are previously stored in the flash memory 11. However, a communication OF 50 for connecting to an external server may be arranged in the digital camera 10 as shown in FIG. 43 so as to initially prepare a part of the control programs in the flash memory 44 as an internal control program while acquire another part of the control programs from the external server as an external control program. In this case, the above-described procedures are realized in cooperation with the internal control program and the external control program.

Moreover, in this embodiment, the processes executed by the CPU 26 are divided into the person detecting task shown in FIG. 22 to FIG. 32 and the imaging task shown in FIG. 33 to FIG. 42. However, these tasks may be further divided into a plurality of small tasks, and furthermore, a part of the divided plurality of small tasks may be integrated into the main task. Moreover, when each of tasks is divided into the plurality of small tasks, the whole task or a part of the task may be acquired from the external server.

Moreover, in this embodiment, the face portion image and/or the rear-of-the-head image is searched for in a camera mode, and an imaging condition is adjusted in a manner different depending on the search result. However, in a reproduction mode, the face portion image and/or the rear-of-the-head image may be searched from a reproduced image so as to adjust a quality of the reproduced image in a manner different depending on the search result. In this case, a process of increasing a brightness of the face portion image or reducing a brightness of the rear-of-the-head image may be adopted.

Although the present invention has been described and illustrated in detail, it is clearly understood that the same is by way of illustration and example only and is not to be taken by way of limitation, the spirit and scope of the present invention being limited only by the terms of the appended claims.

What is claimed is:

1. An image processing apparatus, comprising:
a first searcher which searches for, from a designated image, one or at least two first partial images each of which represents a face portion;
a second searcher which searches for, from the designated image, one or at least two second partial images each of which represents a rear of a head in association with a searching process of said first searcher;
a first setter which sets a region corresponding to the one or at least two first partial images detected by said first searcher out of regions on the designated image as a reference region for an image quality adjustment;
a second setter which sets a region different from a region corresponding to the one or at least two second partial images detected by said second searcher out of the regions on the designated image as the reference region; and
a start-up controller which selectively starts up said first setter and said second setter so that said first setter has priority over said second setter.

2. An image processing apparatus according to claim 1, further comprising:
an upper-body image searcher which searches for, from the designated image, a partial image coincident with a first dictionary image representing an outline of an upper body as an upper-body image; and
a head image searcher which searches for, from the upper-body image, a partial image coincident with a second dictionary image representing an outline of a head as a head image, wherein said second searcher searches for, from the head image, a partial image coincident with a third dictionary image representing the rear of the head as the second partial image.

3. An image processing apparatus according to claim 1, wherein said first searcher searches for a partial image coincident with a fourth dictionary image representing the face portion as the first partial image, and said first setter includes a first reference region setter which sets the reference region by noticing the face portion when a matching degree between the first partial image and the fourth dictionary image is equal to or more than a reference and a second reference region setter which sets the reference region by noticing the upper body when the matching degree between the first partial image and the fourth dictionary image falls below the reference.

4. An image processing apparatus according to claim 1, further comprising:
an imager, having an imaging surface capturing a scene through a focus lens, which outputs an image; and
a distance adjuster which adjusts a distance from the focus lens to the imaging surface, based on an image belonging to the reference region.

5. An image processing apparatus according to claim 4, further comprising:
an aperture unit which adjusts a light amount irradiated onto the imaging surface;
an opener which opens said aperture unit by a predetermined amount, corresponding to a detection of said second searcher, and
a readjuster which readjusts the distance from the focus lens to the imaging surface in parallel with an opening process of said opener.

6. An image processing apparatus according to claim 4, further comprising:
a photometer which performs a photometry in a manner different depending on a detected result of said first searcher and/or said second searcher; and
an exposure adjuster which adjusts an aperture amount of said aperture unit and/or an exposure time period of said imager, based on a photometric result of said photometer.

7. An image processing apparatus according to claim 4, further comprising:
a generator which generates a flash light toward forward of said imaging surface; and
a flash light adjuster which adjusts a generation manner of said generator so as to be different depending on the detected result of said first searcher and/or said second searcher.

8. A computer program embodied in a tangible medium, which is executed by a processor of an image processing apparatus, said program comprising:
a first searching step of searching for, from a designated image, one or at least two first partial images each of which represents a face portion;
a second searching step of searching for, from the designated image, one or at least two second partial images each of which represents a rear of a head in association with a searching process of said first searching step;
a first setting step of setting a region corresponding to the one or at least two first partial images detected by said first searching step out of regions on the designated image as a reference region for an image quality adjustment;
a second setting step of setting a region different from a region corresponding to the one or at least two second partial images detected by said second searching step out of the regions on the designated image as the reference region; and
a start-up controlling step of selectively starting up said first setting step and said second setting step so that said first setting step has priority over said second setting step.

9. An image processing method executed by an image processing apparatus, comprising:
a first searching step of searching for, from a designated image, one or at least two first partial images each of which represents a face portion;
a second searching step of searching for, from the designated image, one or at least two second partial images each of which represents a rear of a head in association with a searching process of said first searching step;
a first setting step of setting a region corresponding to the one or at least two first partial images detected by said first searching step out of regions on the designated image as a reference region for an image quality adjustment;
a second setting step of setting a region different from a region corresponding to the one or at least two second partial images detected by said second searching step out of the regions on the designated image as the reference region; and
a start-up controlling step of selectively starting up said first setting step and said second setting step so that said first setting step has priority over said second setting step.
